(19) United States
(12) Patent Application Publication
(10) Pub. No.: US 2012/0268708 A1
(43) Pub. Date: Oct. 25, 2012

(54) LIQUID CRYSTAL DISPLAY AND MANUFACTURING METHOD THEREOF

(75) Inventor: Kazuya CHIDA, Kumamoto (JP)

(73) Assignee: MITSUBISHI ELECTRIC CORPORATION, Chiyoda-ku (JP)

(21) Appl. No.: 13/443,040

(22) Filed: Apr. 10, 2012

(30) Foreign Application Priority Data
Apr. 22, 2011 (JP) 2011-096218

(51) Int. Cl. G02F 1/1339

(52) U.S. Cl. 349/153

(57) ABSTRACT

A liquid crystal display includes: a pair of substrates, which face with each other, wherein at least one of the pair of substrates is made of ultra-thin glass; a liquid crystal member arranged between the pair of substrates; a main seal pattern arranged between the pair of substrates to bond the pair of substrates and to surround and seal the liquid crystal material; and a gap maintaining member, which is arranged to at least a substrate edge in the vicinity of a substrate edge formed by cutting the at least one of the substrates made of the ultra-thin glass, and which maintains a distance between the pair of substrates in a predetermine range.

### CROSS-REFERENCE TO RELATED APPLICATION

This application claims priority from Japanese Patent Application No. 2011-096218 filed on Apr. 22, 2011, the entire subject matter of which is incorporated herein by reference.

### TECHNICAL FIELD

This disclosure relates to a liquid crystal display using ultra-thin glass and a manufacturing method thereof.

### BACKGROUND

In recent years, a liquid crystal display for curvature (curved display) or a dual-screen displayable liquid crystal display (dual-screen display), in which parallax barriers are arranged on a display surface of a liquid crystal panel, has been proposed. As a common configuration of these liquid crystal displays, ultra-thin glass is used. For example, JP-A-2003-337550 describes a liquid crystal panel using a glass substrate having ultra-thin thickness of about 0.01 to 0.15 mm, as ultra-thin glass, in order to realize a flexibly bendable liquid crystal panel that may be also used in a curved display. Further, JP-A-H5-249422 describes a liquid crystal panel used for the reflective liquid crystal display apparatus using a glass substrate having ultra-thin thickness of about 0.1 to 0.2 mm as ultra-thin glass provided on one substrate side only and a method of cutting the same.

### SUMMARY

In a liquid crystal display using ultra-thin glass having a substrate thickness of about 0.1 mm, such as a dual-screen display, a curved display, or a reflection type display, as described in JP-A-H5-249422, at least one glass substrate is thinned to produce ultra-thin glass in a state of a cell substrate of a mother board size, and then the glass is divided into a size of each liquid crystal panel. In cutting the glass for division, a scribe line that is a cutting wound as the origin of cutting is formed on the glass surface. Specifically, a scribe line is formed by a scribe cutter (or scribe wheel) on the surface of the ultra-thin glass between seal patterns of an adjacent panel. When this scribe cutter (or scribe wheel) becomes in contact with the surface of the ultra-thin glass and a load is applied to the ultra-thin glass, a large deflection occurs on the ultra-thin glass. Since the amount of deflection is changed depending on the difference in space between the scribe line and the seal, rebound stress is not uniform, and thus it is difficult to successfully form the scribe line. Further, even on the same scribe line, due to the influence of non-uniformity of seal position/width/scribe line precision, the space is not uniformly maintained, and the scribe condition varies. As a result, inferiorities, such as remaining of cut damages including fine cracks on the cut surface and cracking during cutting, occur to reduce the yield. Further, in structure, the liquid crystal display using the ultra-thin glass is generally weakened against the application of external stress, and thus the problem remains in terms of durability of the liquid crystal display itself, such as leakage of liquid crystals due to the damage of the ultra-thin glass.

Accordingly, with taking into consideration of the above-described situations, and this disclosure provides at least a liquid crystal display using ultra-thin glass, which is to be produced at low cost through improvement of durability and reliability and high yield.

A liquid crystal display of this disclosure comprises: a pair of substrates, which face with each other, wherein at least one of the pair of substrates is made of ultra-thin glass; a liquid crystal member arranged between the pair of substrates; a main seal pattern arranged between the pair of substrates to bond the pair of substrates and to surround and seal the liquid crystal material; and a gap maintaining member, which is arranged to at least a substrate edge in the vicinity of a substrate edge formed by cutting the at least one of the substrates made of the ultra-thin glass, and which maintains a distance between the pair of substrates in a predetermine range.

In the liquid crystal panel using ultra-thin glass and the liquid crystal display, it is possible to form a stable scribe line and to reinforce the vicinity of the end surface of the ultra-thin glass of the liquid crystal panel during production.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a plan view illustrating a liquid crystal panel in a liquid crystal display according to a first illustrative embodiment of this disclosure;

FIG. 2 is a cross-sectional view illustrating a liquid crystal panel in a liquid crystal display according to the first illustrative embodiment of this disclosure;

FIG. 3 is a flowchart illustrating an assembling process in a method of manufacturing a liquid crystal panel according to the first illustrative embodiment of this disclosure;

FIGS. 4A and 4B are plan views illustrating a mother TFT substrate and a mother CF substrate in a process of manufacturing a liquid crystal panel according to the first illustrative embodiment of this disclosure;

FIGS. 5A, 5B and 5C are cross-sectional views illustrating a mother TFT substrate and a mother CF substrate in a process of manufacturing a liquid crystal panel according to the first illustrative embodiment of this disclosure;

FIGS. 6A and 6B are plan views and a cross-sectional view illustrating a mother TFT substrate and a mother CF substrate in a scribe process in a process of manufacturing a liquid crystal panel according to the first illustrative embodiment of this disclosure;

FIGS. 7A and 7B are cross-sectional views illustrating the vicinity of a signal terminal in a scribe process and a cell dividing process in a process of manufacturing a liquid crystal panel according to the first illustrative embodiment of this disclosure;

FIGS. 8A, 8B and 8C are cross-sectional views illustrating a mother TFT substrate and a mother CF substrate in a process of manufacturing a liquid crystal panel according to a modified first illustrative embodiment of this disclosure;

FIG. 9 is a cross-sectional view illustrating a mother TFT substrate and a mother CF substrate in a scribe process in a process of manufacturing a liquid crystal panel according to the modified first illustrative embodiment of this disclosure;

FIGS. 10A and 10B are plan views and a cross-sectional view illustrating a mother TFT substrate and a mother CF substrate in a process of manufacturing a liquid crystal panel according to the modified the first illustrative embodiment of this disclosure;

FIGS. 11A and 11B are plan views and a cross-sectional view illustrating a mother TFT substrate and a mother CF substrate in a scribe process in a process of manufacturing a liquid crystal panel according to the modified the first illustrative embodiment of this disclosure;

FIG. 12 is a plan view illustrating a liquid crystal panel in a liquid crystal display according to a second illustrative embodiment of this disclosure;

FIG. 13 is a cross-sectional view illustrating a liquid crystal panel in a liquid crystal display according to the second illustrative embodiment of this disclosure;

FIGS. 14A and 14B are cross-sectional views illustrating a mother TFT substrate and a mother CF substrate in a process of manufacturing a liquid crystal panel according to the second illustrative embodiment of this disclosure; and

FIGS. 15A and 15B are cross-sectional views illustrating a mother TFT substrate and a mother CF substrate in a scribe process in a process of manufacturing a liquid crystal panel according to a modified the second illustrative embodiment of this disclosure.

### DETAILED DESCRIPTION

### The First Illustrative Embodiment

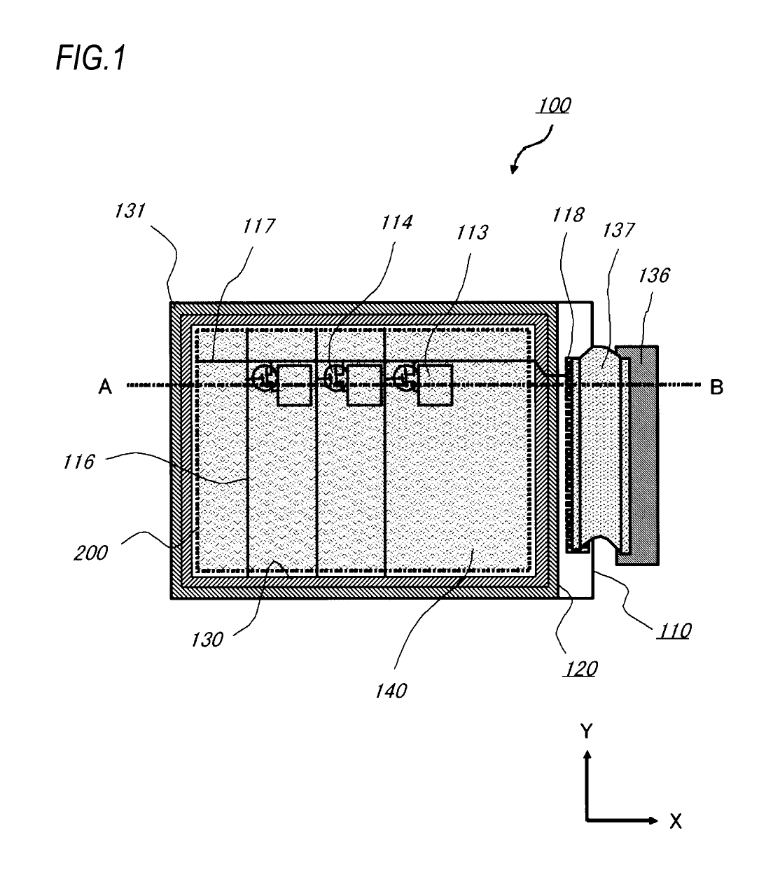

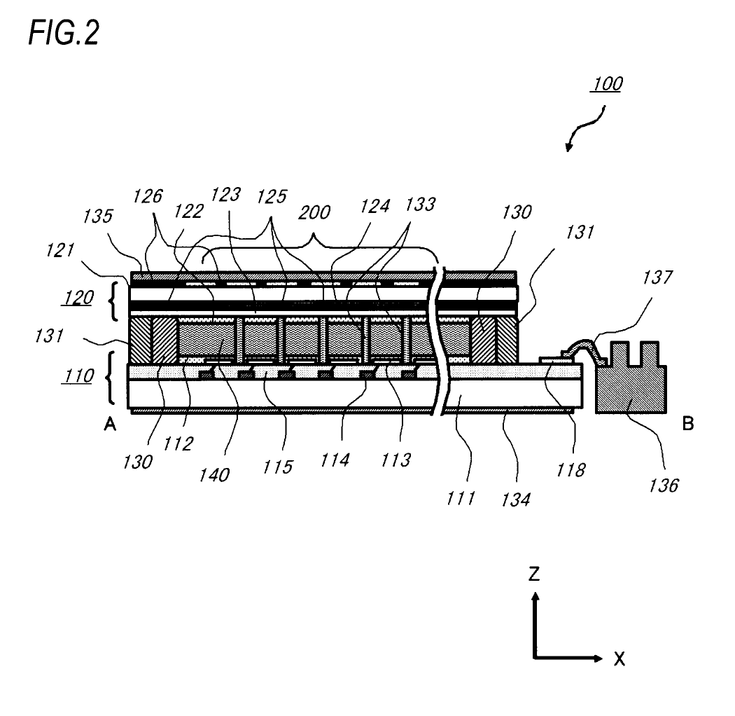

The configuration of a liquid crystal panel 100 that is used in a liquid crystal display according to the first illustrative embodiment of this disclosure will be described with reference to schematic views of FIGS. 1 and 2. FIG. 1 is a plan view illustrating the whole configuration of a liquid crystal panel, and FIG. 2 is a cross-sectional view taken along cross-sectional line A-B in FIG. 1. Here, as an example, a TFT (Thin Film Transistor) type dual-screen display liquid crystal panel will be described. This liquid crystal panel 100, as shown in the drawing, includes a switching element substrate (hereinafter, TFT substrate) 110 on which TFTs are arranged in an array as switching elements, a color filter substrate (hereinafter, CF substrate) 120 on which color filters are formed, and a main seal pattern 130 sealing a gap between the CF substrate 120 and the TFT substrate 110, which are arranged to surround at least a display region 200 that is a region corresponding to a display surface that displays an image when the liquid crystal panel 100 operates. Additionally, between the TFT substrate 110 and the CF substrate 120, a plurality of column spacers 133 that form and maintain the gap in a predetermined range, in other words, column spacers 133 are arranged in the display region 200 to maintain a distance between the substrates in a predetermined range. A liquid crystal layer 140 is arranged in a manner that a liquid crystal member is sandwiched between the regions that correspond to at least the display region 200 in the gap between the CF substrate 120 and the TFT substrate 110, which are sealed by the main seal pattern 130 and are maintained by the column spacers. In other words, the liquid crystal member is surrounded and sealed by the main seal pattern 130. Here, as the liquid crystal material, a general Twisted Nematic (TN) type liquid crystal member is used. On the other hand, the display region 200 is used as all of the region, on the TFT substrate 110 and on the CF substrate 120 of the liquid crystal panel 100, and the region that is sandwiched between the both substrates, and then in the specification, the same meaning is to be used.

The above-described TFT substrate 110 has an alignment film 112 that aligns liquid crystals on one surface of the glass substrate 111 that is a transparent substrate made of typical glass with a thickness of about 0.7 mm, pixel electrodes 113 provided on a lower portion of the alignment film 112 to apply a voltage for driving the liquid crystals, TFTs 114 switching elements supplying a voltage to the pixel electrodes 113, an insulating film 115 covering the TFTs 114, a plurality of gate wires 114 and source wires 117 which are wires supplying signals to the TFTs 114, a signal terminal 118 receiving the signals that are supplied to the TFTs 114 from outside, and a transfer electrode (not illustrated) for transferring the signals input from the signal terminal 118 to a counter electrode 123. Further, on the other surface of the glass substrate 111, a polarizing plate 134 is provided.

On the other hand, the above-described CF substrate 120 has an alignment film 122 that aligns liquid crystals on one surface of the glass substrate 121 that is a transparent substrate made of ultra-thin glass with a thickness of about 0.1 mm, a common electrode 123 arranged on a lower portion of the alignment film 122 to generate an electric field between the pixel electrodes 113 on the TFT substrate 110 and to drive the liquid crystals, and black matrices (BM) 125 which are light-shielding layers provided to shield between the color filters 124 provided on a lower portion of the common electrode 123 or to shield a frame region arranged on an outside of the region corresponding to the display region 200. Further, on the other surface of the glass substrate 121, a parallax barrier 126, which is light-shielding layer that separates the viewing direction into two directions, is formed on positions shifted from the BM 125 arranged in the pixel. Additionally, a polarizing plate 135 is provided on the outer side than the parallax barriers 126. As the color filter 124, color material layers, in which pigment or the like is dispersed into resin, may be selected, and the color material layers having different colors are regularly arranged to function as filters that selectively transmit light in a specified wavelength range, such as red, green, and blue. The BM 125 is arranged in the frame region on the outside of the display region 200 in addition to the region between the color filter 124, and is formed over the almost entire region of the frame region on the CF substrate 120. The BM 125 shields the light transmission through the CF substrate 120 in the frame region in which display is unnecessary. As the light-shielding layer configured by the BM 125 and the parallax barrier 126, a metal-based material using a laminated film of chrome and chrome oxide or a resin-based material in which black particles are dispersed in the resin may be selected. On the other hand, on the lower layer than the alignment film, an overcoat layer configured by a transparent resin film may be provided to cover the color filter 124 and the BM 125.

Further, the TFT substrate 110 and the CF substrate 120 are bonded through the main seal pattern 130 and then are maintained at a predetermined substrate interval by the column spacers 133 arranged on the display region 200. Further, the transfer electrode and the common electrode 123 are electrically connected to each other by a transfer material, and a signal input from the signal terminal 118 is transferred to the common electrode 123. The transfer material may be replaced by mixing of conductive particles in the main seal pattern 130 or may be omitted. In an embodiment of this disclosure, since the main seal pattern 130 and the common electrode 123 contact each other as can be seen from FIG. 1 using the main seal pattern 130 in which conductive particles are mixed, the transfer electrode and the common electrode 123 are electrically connected through the main seal pattern 130 by arranging the transfer electrode to overlap the main seal pattern 130 in the plane and making the transfer electrode contact the main seal pattern 130. In addition, the liquid crystal panel 100 includes a control board 136 generating a drive signal, a FFC (Flexible Flat Cable) 137 electrically connecting the control board 136 to the signal terminal 118, and a backlight unit that is a light source (which is typically arranged toward the outside of the TFT substrate 110 that is the opposite side to the CF substrate 120, but is not illustrated herein). The liquid crystal panel 100 is accommodated in a housing (not illustrated) together with the above-described members in a state where an outer portion of the CF substrate 120 in the display region 200 that is the display surface is opened.

Then, the configuration of the frame region which becomes a panel peripheral region, which is one of characteristic portions of the liquid crystal panel 100 according to the first illustrative embodiment will be described supplementarily. As illustrated in FIG. 1, on the outside of the main seal pattern 130 of the frame region in the liquid crystal panel 100 according to the first illustrative embodiment of this disclosure, a gap maintaining member 131 is provided to maintain a distance between the substrates (gap between the substrates) when cutting the substrates. In the first illustrative embodiment of this disclosure, as shown in FIGS. 1 and 2, the gap maintaining member 131 is provided to fill between the panels and is united by the same resin material as the main seal pattern 130. As illustrated in FIG. 1, in the complete liquid crystal panel 100, the gap maintaining member 131 is provided up to the edge of the CF substrate 120.

The liquid crystal display and the liquid crystal panel 100 according to the first illustrative embodiment of this disclosure configured as described above is operated as follows. For example, if an electrical signal is input from the control board 136, a drive voltage is applied to the pixel electrode 113 and the common electrode 123, and then the direction of liquid crystal molecules in the liquid crystal layer 140 is changed to match the drive voltage. Further, light emitted from the backlight unit is transmitted to an observer side or intercepted through the TFT substrate 110, the liquid crystal layer 140, and the CF substrate 120, and thus an image or the like is displayed on the display region 200 of the liquid crystal panel 100. On the other hand, since the liquid crystal display according to the first illustrative embodiment of this disclosure is a dual-screen display liquid crystal panel, the light that is transmitted through the CF substrate 120 is limited to a viewing angle range in two predetermined angle directions by the parallax barriers 126. Specifically, the image or the like is displayed on the display surface with having a viewing angle range in two directions of +X direction and −X direction in the drawing. Further, display pixels that correspond to the viewing angle range in two directions are set to display different images, and thus the liquid crystal display functions as a dual-screen display light crystal panel that displays different images in the viewing angle range in two directions. Further, since the liquid crystal display according to the first illustrative embodiment has the characteristic configuration in the frame region as described above, the dual-screen display liquid crystal panel having high durability can be obtained although the dual-screen display liquid crystal panel using the ultra-thin glass has the problem in terms of durability against the application of external stress.

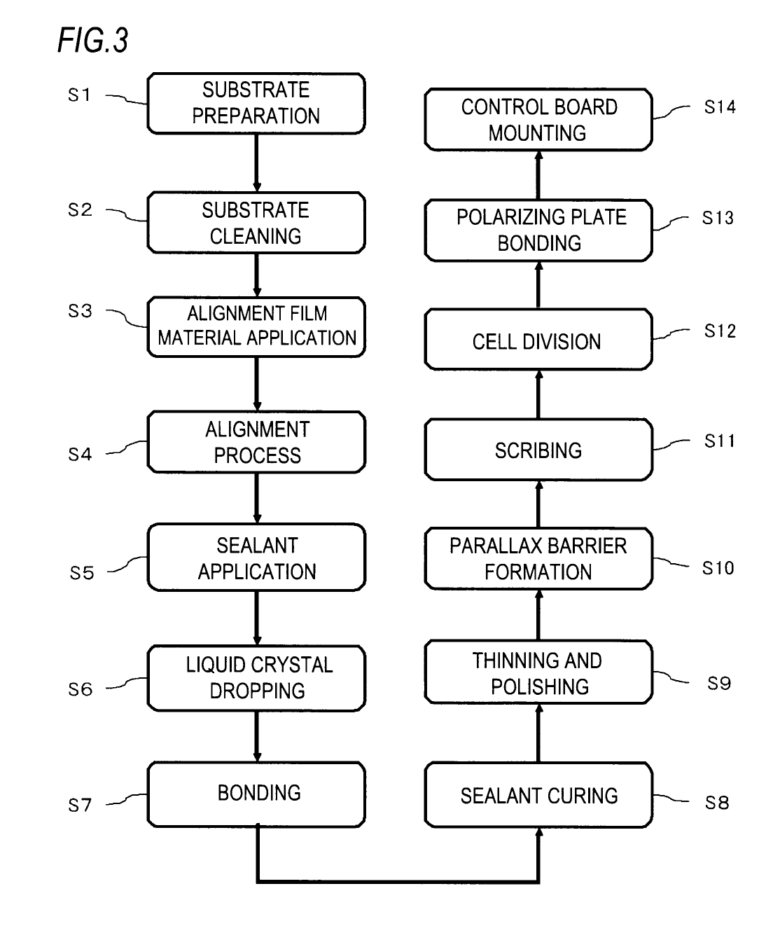

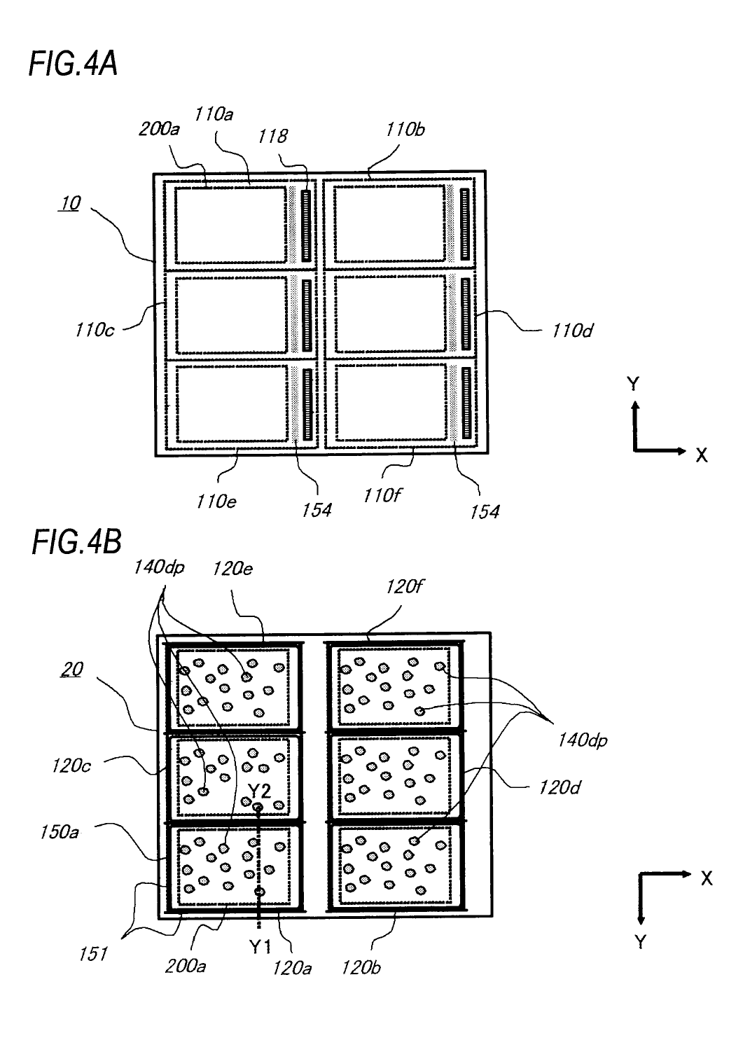

Then, a method of manufacturing a liquid crystal display and the liquid crystal panel 100 according to the first illustrative embodiment of this disclosure will be described. Typically, one or plural liquid crystal panels are cut out (multi-surface extraction) from a mother substrate that is larger than the final shape of the liquid crystal panel. Here, the description will focus on the characteristic assembling process according to this disclosure, and a case of cutting out the six liquid crystal panels from the mother substrates will be described as an example. Hereinafter, a process of assembling the liquid crystal panel 100 according to the first illustrative embodiment of this disclosure will be described according to a flowchart illustrated in FIG. 3, and the characteristic process will be properly described using detailed explanatory drawings of FIGS. 4 to 7.

First, in a substrate preparing process, a mother TFT substrate 10 for cutting out TFT substrates 110 and a mother CF substrate 20 for cutting out CF substrates 120 are prepared (Si), before being bonded to each other. In preparing the mother TFT substrate 10 and the mother CF substrate 20, although the CF substrate 120 is formed as the ultra-thin glass by finally thinning the glass, in order to facilitate the performing of the following processes, it is manufactured from the mother TFT substrate 10 and the mother CF substrate 20 which are made of glass with a thickness of 0.5 to 1.5 mm until the middle process. Here, both the mother TFT substrate 10 and the mother CF substrate 20 are prepared as the substrates made of glass with a thickness of 0.7 mm. FIGS. 4A and 4B respectively show the mother TFT substrate 10 and the mother CF substrate 20 in a process just before a bonding process (S7) that is a process of bonding the mother TFT substrate 10 and the mother CF substrate 20.

First, as shown in FIG. 4A, 6 TFT substrates 110a to 110f are formed on the mother TFT substrate 10, and in the following process, the TFT substrates 110a to 110f are cut out from the mother TFT substrate 10. In addition, for example, in the TFT substrate 110a, as described above, a pixel electrode 113 that drives liquid crystals, a TFT 114, a gate wiring 116, and a source wiring 117 (all of them are not shown in FIG. 4A) are formed on the signal terminal 118 for receiving a signal from the outside or the display region 200a that is a region corresponding to the display surface when the liquid crystal panel is completed. Further, as the characteristic configuration, a seal peeling auxiliary layer 154 is arranged on the surface of the TFT substrate 110a in the region between the display region 200a and the signal terminal 118. This seal peeling auxiliary layer 154 is provided on the surface of the TFT substrate 110a that corresponds to the position according to the cut end portion of the CF substrate 120a in FIG. 4B, and is effective at the time of cutting the CF substrate 120a. However, since the role of the seal peeling auxiliary layer 154 will be described in detail when the manufacturing method is described hereinafter, the description thereof will be omitted. Further, although the illustration and description thereof is omitted, the TFT substrates 110B to 110F have the same configuration as the switching element substrate 110a. On the other hand, since the formation of the signal terminal 118 and the TFT 114 is the same as the method of manufacturing the TFT substrate in a typical liquid crystal panel, the detailed manufacturing method thereof will be omitted.

On the other hand, as illustrated in FIG. 4B, 6 CF substrates 120a to 120f are formed on the mother CF substrate 20, and in the following process, the CF substrates 120a to 120f are cut out from the mother CF substrate 20. In addition, for example, in the CF substrate 120a, as described above, a common electrode 123 that drives liquid crystals, a color filter 124, a BM 125, and a column spacer 133 (all of them are not illustrated) are formed on the display region that is a region corresponding to the display face when the liquid crystal panel 100 is completed. On the other hand, since the forming of the common electrode 123, the color filter 124, the BM 125, and the column spacer 133 is the same as the method of manufacturing the color filter substrate in a typical liquid crystal panel, the detailed manufacturing method thereof will be omitted.

In a substrate cleaning process, the mother TFT substrate 10 on which the TFT substrates 110a to 110f are formed as described above is cleaned (S2). Then, in a process of applying an alignment film material, an alignment film material is spread and formed on one surface of the mother TFT substrate 10 (S3). In this process, for example, the alignment film material that is made of an organic film is spread by a print method, burning by a hot plate or the like, and then dried. Thereafter, in a rubbing process, rubbing of the alignment film material is performed, and the surface of the alignment film material is aligned to form an alignment film 112 (S4).

Further, similarly to S2 to S4, an alignment film 122 is formed by performing cleaning, applying of an alignment film material, and rubbing with respect to the mother CF substrate 20 on which the CF substrates 120a to 120f are formed. Then, in a sealant applying process, by a screen printing device, a sealant is spread on one side of the mother TFT substrate 10 or the mother CF substrate 20, and a sealant that becomes main seal patterns 130a to 130f that are shaped to surround the display region 200 and, a gap maintaining member 131 arranged on the outside of the main seal patterns 130a to 130f are finally formed (S5).

Specifically, for example, as illustrated in FIG. 4B, in the CF substrates 120a to 120f, which are formed on the mother CF substrate 20, main sealants 150a to 150f having a plurality of seal regions that surround and seal the liquid crystal member later and dummy sealants 151 arranged along respective side of outside of the main sealants 150a to 150f. Further, the dummy sealants 151 are arranged to match external shapes of the CF substrates 120a to 120f, that is, to match a cut line when the CF substrates 120a to 120f are cut out from the mother CF substrate 20. Further, the main seal patterns 130a to 130f and the gap maintaining member 131 are made of the same sealant, and are simultaneously applied and formed using the common sealant as a print paste. Since the gap maintaining member 131 can be arranged without specially increasing the manufacturing processes by simultaneously forming the common sealant that forms the main seal patterns 130a to 130f and the gap maintaining member 131 through a screen printing device, screen printing is used in the first illustrative embodiment of this disclosure. However, even in the case of applying by nozzle (dispenser method), in which the processing time is somewhat increased due to the movement time of the nozzle for applying the gap maintaining member 131, the gap maintaining member 131 may be arranged without causing great increase of processing time such as sealant exchanging time or the like through the use of common sealant.

In a liquid crystal dropping process, a large number of droplet-shaped liquid crystal member 140dp is dropped in a region surrounded by the main sealants 150a to 150f on one surface of the mother TFT substrate 10 or the mother CF substrate 20 (S6). Specifically, for example, with respect to the CF substrates 120a to 120f of the mother CF substrate 20, as shown in FIG. 4B, a large number of droplet-shaped liquid crystal member 140dp is dropped into the seal region which is surrounded by the main sealants 150a to 150f and seals the liquid crystal member so that a predetermined amount of liquid crystal layer 140 in the whole is formed. As described above, it is exemplified that the liquid crystal layer 140 is formed by filling the liquid crystals using a so-called One Drop Filling (ODF) method. However, in the case of using a vacuum injection method, an opened liquid crystal inlet, rather than a completely closed liquid crystal inlet, is partially formed on the main sealants 150a to 150f. Further, the dummy sealants 151, which are arranged along the respective sides on the outside of the main sealants 150a to 150f, are formed along the outside of the main sealants 150a to 150f except for the liquid crystal inlet. On the other hand, in the case of using the vacuum injection method, as a matter of course, the liquid crystal member is injected through the liquid crystal inlet after bonding, and thus the formation of the above-described liquid crystal droplet-shaped liquid crystal member 140dp is omitted.

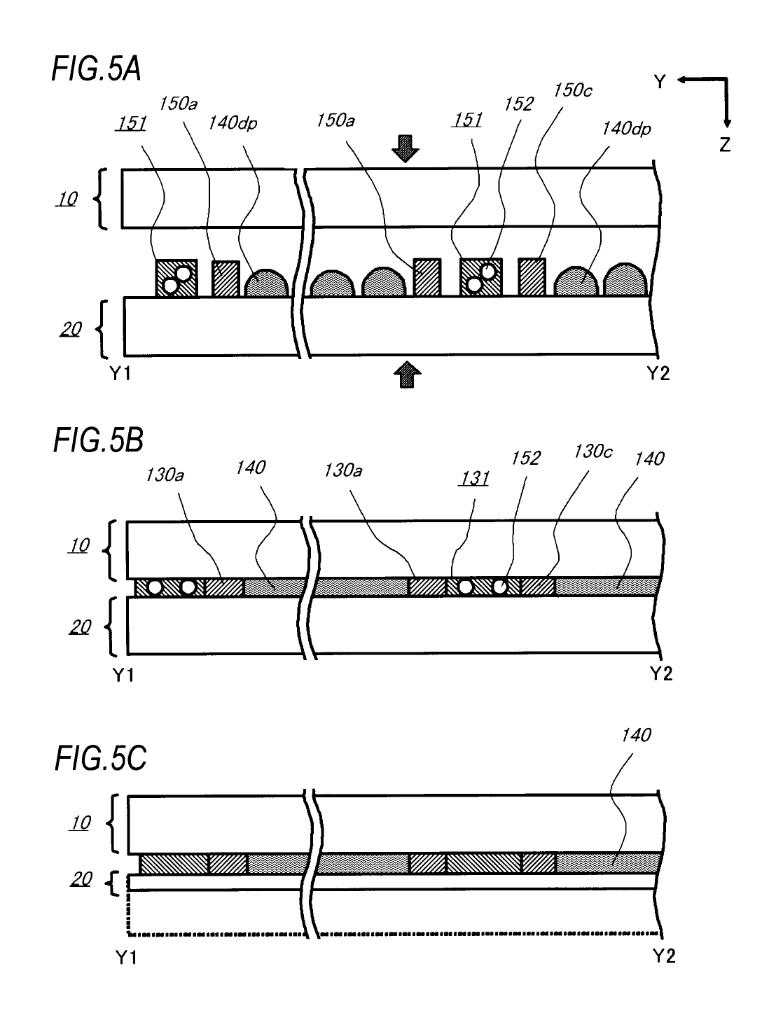

In a bonding process, a cell substrate is formed by bonding the mother TFT substrate 10 and the mother CF substrate 20 (S7). Specifically, the mother TFT substrate 10 and the mother CF substrate 20 prepared as shown in FIGS. 4A and 4B face with each other to correspond to the TFT substrates 110a to 110f and the CF substrates 120a to 120f, respectively, and then are closed with each other and bonded in a vacuum state. FIGS. 5A to 5C are a cross-sectional view illustrating a manufacturing process after S7. FIGS. 5A to 5C shows a cross-section of the mother CF substrate 20 of FIG. 4B in a cross-sectional line Y1-Y2 and illustrates the situation in the frame region of the CF substrate 120a and the TFT substrate 110a in the manufacturing process after S7. In a state before the mother TFT substrate 10 and the mother CF substrate 20 are bonded as shown in FIG. 5A, between the CF substrate 120a and the CF substrate 120c which are adjacently arranged (corresponding to a cutting line when the CF substrate 120a and the CF substrate 120c are separated to be cut), the dummy sealant 151 is formed between the main sealant 150a and the main sealant 150c, and in the end portion on the opposite side to the side to which the CF substrate 120c is adjacent in the CF substrate 120a, only the dummy sealant 151 is arranged on the outside of the main sealant 150a (corresponding to the cutting line when the unwanted glass portions around the CF substrate 120a and the mother CF substrate 20 are separated and cut).

The mother TFT substrate 10 and the mother CF substrate 20 oppositely arranged are close to each other in a direction of arrows and are bonded as shown in FIG. 5B. As a result, the main sealants 150a and 150c and the dummy sealant 151 are sandwiched by the mother TFT substrate 10 and the mother CF substrate 20, and are spread by being pressed, and in an adjacent portion of the main sealant 150a and the main sealant 150c, the main sealant 150a, the main sealant 150c, and the dummy sealant 151 are united to form the main seal pattern 130a, the main seal pattern 130c, and the gap maintaining member 131. Further, in the end portion on the opposite side to the adjacent side, the main sealant 150a and the dummy sealant 151 are united to form the main seal pattern 130a and the gap maintaining member 131. Further, spacers 152 are mixed in the dummy sealant 151, for example, cylindrical type (also called a micro-rod or the like) spacers that are made of glass are often used. When the dummy sealant 151 is pressed, the substrate spacing between the mother TFT substrate 10 and the mother CF substrate 20 is maintained by the spacers 152, and the gap maintaining member 131 that is formed when the dummy sealant 151 is pressed serves to maintain the substrate spacing between the mother TFT substrate 10 and the mother CF substrate 20. On the other hand, if the spacer 152 that is mixed in the dummy sealant 151 is a spacer that maintains the distance between the substrates (gap between the substrates) in a predetermined range, the same effect can be obtained. The spacer is not limited to the cylindrical spacer made of glass, but may be a spherical spacer. The material of the spacer is not limited to glass that is solid and non-deformable, but may be a relatively hard elastic body (for example, acrylic resin) which can maintain the substrate spacing (distance between the substrates) in the predetermined range even if it is deformed in the predetermined range in a predetermined pressure range.

In a sealant curing process, the sealants, such as the main sealants 150a to 150f and the dummy sealant 151, which are formed between the mother TFT substrate 10 and the mother CF substrate 20 is completely cured in a state where the mother TFT substrate 10 and the mother CF substrate 20 are bonded together (S8). This process is performed by applying heat or irradiating ultraviolet rays to match the material of the sealants. In the first illustrative embodiment of this disclosure, the sealants are cured by a method of irradiating ultraviolet rays that are suitably to the ODF method. By this process, the mother TFT substrate 10 and the mother CF substrate 20 are fixed in a state where positional relationship is kept.

Further, if thinning the glass substrate that forms at least one of the TFT substrate 10 and the CF substrate 20 in order to lighten the liquid crystal panel 100 or to form a dual-screen display liquid crystal panel according to an embodiment of this disclosure, such thinning may be performed in a bonded state of the substrates. According to the first illustrative embodiment of this disclosure, a thinning and polishing process is performed (S9). Specifically, a thinning process by chemical solution or mechanical polishing may be selected. In the case of thinning both the TFT substrate 10 and the CF substrate 20 using the thinning process by chemical solution that is suitable to the ultra-thin glass processing on the control of the substrate thickness, peripheral seal for preventing chemical solution from flowing between the substrates is performed with respect to peripheral portions of the mother TFT substrate 10 and the mother CF substrate 20. Then, the bonded mother TFT substrate 10 and the mother CF substrate 20 are entirely immersed in the chemical solution, and the surfaces of the mother TFT substrate 10 and the mother CF substrate 20 are scrapped to thin the substrates. Further, in the case of thinning only one of the TFT substrate 10 and the CF substrate 20, for example, in the case of thinning only the CF substrate 20 according to the first illustrative embodiment of this disclosure, the thinning may be performed by shaving only the surface of the mother CF substrate 20 in a state where a protection layer such as resist is formed on the surface of the mother TFT substrate 20 in addition to the peripheral seal. As a result, as shown in FIG. 5C, a cell substrate in which only the CF substrate 20 is thinned to ultra-thin glass of about 0.1 mm can be obtained.

In addition, a parallax barrier forming process is performed to form parallax barriers 126 made of light-shielding layers, which function as a dual-screen display liquid crystal panel, on the surface of the side of the thinned mother CF substrate 20 (S10). Specifically, a metal-based material using a laminated film of chrome and chrome oxide or a resin-based material in which black particles are dispersed in the resin is formed according to the material that forms the parallax barrier 126, and a patterning process according to the material that forms each parallax barrier 126 is performed to form a shape having an opening in a predetermined position for functioning as the parallax barrier 126. Through the above-described process, the mother cell substrate 30 is formed

Then, in a scribe process, a line-shaped scribe wound (that is called a scribe line), which is the origin of cutting, is formed on the surfaces of the mother TFT substrate 10 and the mother CF substrate 20 (S11). Typically, the cutting of the glass substrate is performed by applying stress in the vicinity of the scribe line after forming the scribe line that is the origin of cutting on the surface of the glass substrate.

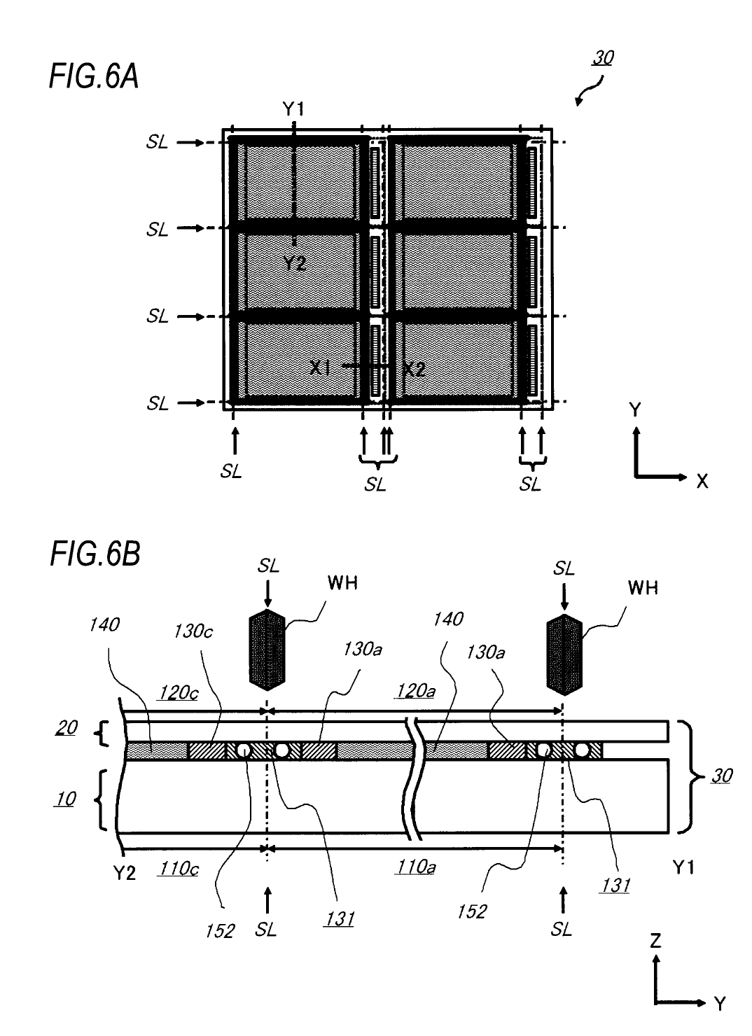

A scribing process for obtaining the characteristic effect according to the first illustrative embodiment of this disclosure will be described in detail with reference to FIGS. 6A and 6B. FIG. 6A is a plan view illustrating a mother cell substrate 30, and FIG. 6B is a cross-sectional view taken along a cross-sectional line Y1-Y2 in FIG. 6A (corresponding to a position of a cross-sectional line Y1-Y2 in FIG. 4B). The scribe line is formed to correspond to the cutting lines of the mother TFT substrate 10 and the mother CF substrate 20, and FIG. 6A illustrates the position of the scribe line SL that is formed on the mother CF substrate 20 made of ultra-thin glass that causes a problem according to the first illustrative embodiment of this disclosure. On the other hand, in FIGS. 6A and 6B, since the parallax barrier 26 that is already formed on the surface of the mother CF substrate 20 has a thickness that is negligible in comparison to the thickness of the mother CF substrate made of ultra-thin glass, and the configuration of the parallax barrier is almost negligible to the contribution to the substrate strength, the illustration of the parallax barrier 26 and the description of the contribution of the parallax barrier 26 to the cutting will be omitted.

As illustrated in FIG. 6B, the scribe line S is formed by a wheel WH of a scribe cutter. However, in forming the scribe line SL on the mother CF substrate 20 that is made of ultra-thin glass, the gap maintaining member 131 for maintaining the distance between the mother CF substrate 20 and the mother TFT substrate 10 in a predetermined range is arranged on the scribe line SL and on the lower layer of the mother CF substrate 20. Accordingly, in order to form the cutting wound, even when the wheel WH is pressed onto the surface of the mother CF substrate 20, the mother CF substrate 20 made of ultra-thin glass of about 0.1 mm is maintained by the gap maintaining member 131 without being deflected, and the repulsive force against the pressing of the wheel WH becomes stabilized. As a result, the rotation of the wheel H on the surface of the mother CF substrate 20 and the scanning of the wheel WH carried out by the rotation become stable, and thus the forming of a stable scribe line SL becomes possible. Further, since the forming of the stable scribe line SL is possible, the occurrence of inferiorities, such as remaining of cut damages including fine cracks on the end surface of the ultra-thin glass due to the cutting in a cell dividing process, which will be described later, and cracking during cutting, can be suppressed. Further, according to the first illustrative embodiment of this disclosure, in the vicinity of the scribe line SL onto which the wheel WH is pressed, the gap maintaining member 131 arranged just below the scribe line SL is formed to fill a region in which the main seal pattern 130c or the main seal pattern 130a is formed. In other words, since the main seal patterns 130a are arranged on both sides of the gap maintaining member 131 and the scribe line SL or the main seal patterns 130c are formed and united, in the vicinity of the scribe line SL, the mother CF substrate 20 is maintained by the united entire configuration to perform the maximum effect of maintaining the mother CF substrate 20, and several effects obtained through maintaining the above-described mother CF substrate 20 can be maximized. Further, at the substrate end where an adjacent panel is not present, for example, even in the lower portion of the scribe line SL on the left in FIG. 6B, the gap maintaining member 131 and the main seal pattern 130a are integrally arranged, and thus the mother CF substrate 20 is maintained by the gap maintaining member. Further, the action and additional effect obtained by the configuration in which the gap maintaining member 131 and the main seal pattern 130a are united can be obtained.

Then, in a cell dividing process, the cell substrate is divided into a plurality of individual cell substrates (S12). In this process, by applying stress in the vicinity of the scribe line SL formed in the above-described scribe process S11, the individual cell substrates are divided into shaped of TFT substrates 110a to 110f and CF substrates 120a to 120f, and thus the mother cell substrate 30 is divided into the individual cell substrates. As described above, the stable scribe line SL can be formed in the scribe process S11. In the vicinity of the scribe line SL, the incidence of fine cracks is reduced, and the linearity of the scribe line SL becomes good. Accordingly, the occurrence of inferiorities, such as remaining of cut damages including fine cracks on the end surface of the ultra-thin glass of the CF substrates 120a to 120f due to the cutting in the cell dividing process and the cracking in the cutting process, can be suppressed.

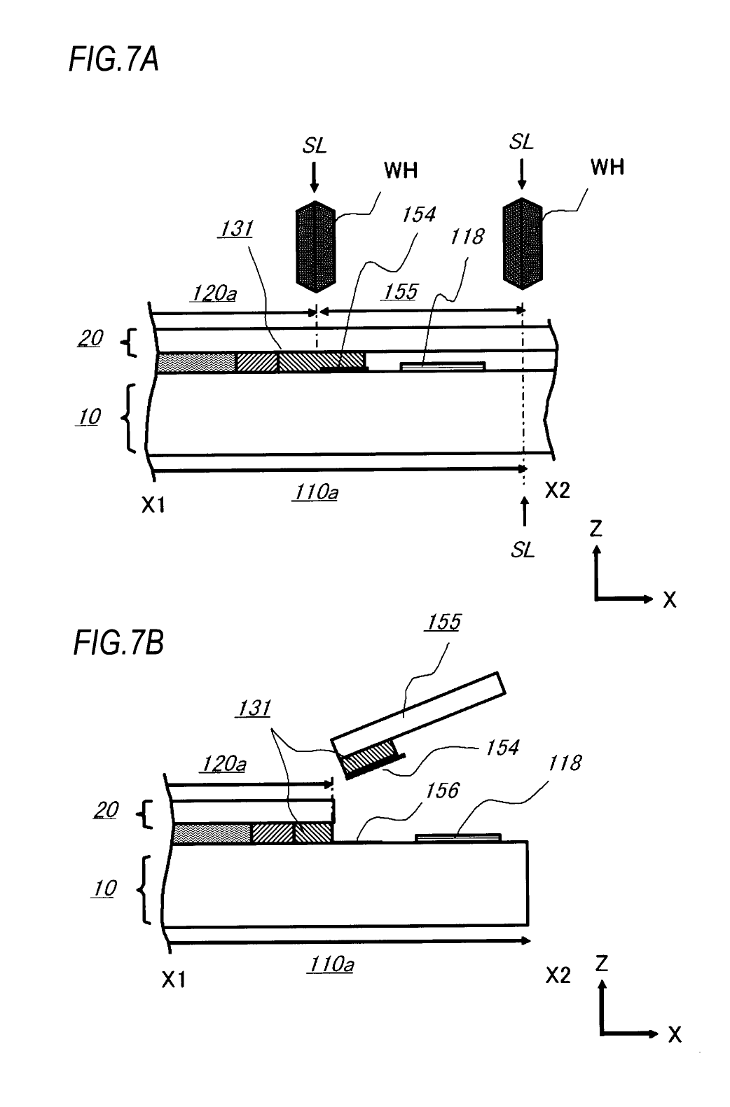

Here, the role of the seal peeling auxiliary layer 154 formed on the surface of the mother TFT substrate 10 as described above will be described in detail with reference to FIG. 4A, properly with reference to FIG. 7. The seal peeling auxiliary layer 154 plays an important role in the cell dividing process S12. Since it is necessary to expose the signal terminal 118 in the TFT substrates 110a to 110f, the mother CF substrate 20 in the portion opposed to the signal terminal 118 becomes an unnecessary portion in the dividing process, and thus is removed. However, according to the first illustrative embodiment of this disclosure, as described above with reference to FIG. 6, the gap maintaining member 131 is arranged in the lower portion of the scribe line SL formed to correspond to the substrate ends of the respective CF substrates 120a to 120f.

FIGS. 7A and 7B illustrates the vicinity of the signal terminal 118 of the TFT substrate 110a as an example and corresponds to the cross section taken along cross-sectional line X1-X2 in FIG. 6A. As shown in FIG. 7A, even in the lower portion of the scribe line SL that is formed at the substrate end at the side where the signal terminal 118 is arranged, the gap maintaining member 131 is arranged to cross over both sides of the scribe line SL. The gap maintaining member 131, in the first illustrative embodiment of this disclosure, is formed by sealant to be bonded to the surfaces of both the mother TFT substrate 10 and the mother CF substrate 20. Accordingly, even the unnecessary portion (a unnecessary cut piece 155 is illustrated in FIG. 7A) of the mother CF substrate 20 that is opposed to the signal terminal 118 is fixed to the mother TFT substrate 10 through the gap maintaining member 131. Because of this, even if the unnecessary cut piece 155 is separated from the CF substrate 120a, it remains to be fixed to the mother TFT substrate 10 (or individual TFT substrate 110a), and is unable to be separated and removed. If the cut piece is compulsorily separated by an external force or the like, the film on the surface of the TFT substrate 110a is peeled off in a state where the film is fixed to the unnecessary cut piece 155. For example, wirings or the like that are drawn to the signal terminal 118 are peeled off together with the unnecessary cut piece 155. However, according to the first illustrative embodiment of this disclosure, the seal peeling auxiliary layer 154 is arranged on the surface of the TFT substrate 110a or the like to which the unnecessary cut piece 155 of the mother CF substrate 20 is fixed by the gap maintaining member 131. The seal peeling auxiliary layer 154 serves to help the peeling of the sealant that forms the gap maintaining member 131 from the TFT substrates 110a to 110f, and for example, is made of a two-layer film having low adhesion or a multi-layer film including the two-layer film. More specifically, a two-layer film in which a silicon nitride film is formed on a-Si film may be used. In the case of the layer configuration as described above, if one side such as a region where the seal peeling auxiliary layer 154 has a relatively large continuous pattern in a millimeter unit, adhesion between the layers becomes low, and thus the layers can be easily peeled off. Accordingly, when the seal peeling auxiliary layer 154 functions in the cell dividing process S12, as shown in FIG. 7B, an upper-layer film of the seal peeling auxiliary layer 154 (indicated as the seal peeling auxiliary layer 154) is separated from the TFT substrate 110a in a state where the upper-layer film is fixed to the gap maintaining member 131, a lower-layer film of the seal peeling auxiliary layer 154 (indicated as the seal peeling auxiliary layer 156) remains on the TFT substrates 110a to 110f, and other configuration is peeled off, and then the damage of the TFT substrates 110a to 110f is suppressed from occurring.

As another type of seal peeling auxiliary layer 154, the seal peeling auxiliary layer 154 may be made of a material that has low adhesion to the surface (for example, insulating film 115) of the TFT substrates 110a to 110f. In this case, in the cell dividing process S12, the seal peeling auxiliary layer 154 is separated from the TFT substrates 110a to 110f in a state where it is fixed to the gap maintaining member 131, and does not remain on the TFT substrates 110a to 110f. As shown in FIG. 7B, the seal peeling auxiliary layer 156 that remains on the TFT substrate 110a will be omitted. Even in this case, only the seal peeling auxiliary layer 154 is separated from the TFT substrates 110a to 110f in a state where it is fixed to the gap maintaining member 131, and other configuration of the TFT substrates 110a to 110f is not peeled off in a state where it is fixed to the gap maintaining member 131. Accordingly, similarly to the case using the two-layer film, the damage of the TFT substrates 110a to 110f is suppressed from occurring.

On the other hand, if using the vacuum injection method, as described above, a liquid crystal inlet that is partially opened is formed on the sealant 130, and in the liquid crystal injecting process that is performed after the cell dividing process, a liquid crystal layer 140 is formed through injection of a liquid crystal member through the liquid crystal inlet. This process, for example, is performed by filling the liquid crystal member in the vacuum injection method through the liquid crystal inlet. In addition, in a sealing process, the liquid crystal inlet is sealed. This process, for example, is performed by sealing in a light-curable resin and then irradiating light thereto.

After being divided into the shape of the liquid crystal panel, in a polarizing plate bonding process, a polarizing plate 134 and a polarizing plate 135 are bonded to the surfaces of the TFT substrate 110 and the CF substrate 120 on the outside of the cell substrate (S13), and in a control board mounting process, a control board 136 is mounted (S14) to complete the liquid crystal panel 100. In addition, a backlight unit is provided on the rear surface side of the TFT substrate 110 that is opposed to the viewing side of the liquid crystal panel 100 through an optical film such as a retardation film, and the liquid crystal panel 100 and its peripheral members are properly accommodated in the frame made of resin or metal. Therefore, the liquid crystal display is completed according to the first illustrative embodiment of this disclosure.

In the liquid crystal panel 100 configuring the liquid crystal display according to the first illustrative embodiment as described above, in the vicinity of the substrate end corresponding to the cutting position of the CF substrate 120 made of ultra-thin glass, the gap maintaining member 131 for maintaining the distance between the TFT substrate 110 oppositely arranged in a predetermined range is provided. Since this gap maintaining member 131 is arranged to at least the substrate end of the CF substrate 120 corresponding to the lower portion of the cutting position, the following effects can be obtained. Specifically, in order to form the cutting wound on the surface of the mother CF substrate 20 from which the CF substrates are cut out, even when the scribe wheel WH is pressed onto the surface of the mother CF substrate 20 that is made of ultra-thin glass, the mother CF substrate 20 is maintained in the lower portion by the gap maintaining member 131 without being deflected. Further, the repulsive force against the pressing of the wheel WH is stabilized, and the rotation of the wheel WH on the surface of the mother CF substrate 20 and the scanning of the wheel WH that is carried out by the rotation become stable. Further, since the forming of a stable scribe line SL becomes possible, the incidence of fine cracks is reduced in the vicinity of the scribe line SL, and the linearity of the scribe line SL becomes better. Further, by performing the cell dividing process on the basis of the scribe line SL formed as above, the remaining of cut damages including fine cracks on the end surface of the ultra-thin glass of the CF substrates 120a to 120f due to the cutting is suppressed, and the occurrence of inferiorities, such as cracking during cutting is suppressed. Further, since the gap maintaining member 131 is arranged to the substrate end of the CF substrate 120 made of an ultra-thin glass substrate, the vicinity of the ultra-thin film end surface can be reinforced, and thus the durability and reliability of the liquid crystal display can be improved.

Further, in the liquid crystal panel 100 configuring the liquid crystal display according to the first illustrative embodiment as described above, the gap maintaining member 131 is formed to fill from the scribe line SL corresponding to the substrate end to a region in which the main seal pattern 130a arranged on both sides or one side of the scribe line SL, and the gap maintaining member 131 and the main seal patterns are formed and united. Accordingly, in the vicinity of the scribe line SL, the mother CF substrate 20 is maintained by the united entire configuration to perform the maximum effect of maintaining the mother CF substrate 20, and several effects obtained by maintaining the above-described mother CF substrate 20 may be maximized. Further, in the lower portion of the CF substrate 120 made of ultra-thin glass, since the gap maintaining member 131 is formed and united to fill from the substrate end of the CF substrate 120 to the region in which the main seal pattern is formed, the vicinity of the end surface of the ultra-thin glass can be reinforced, and thus the improvement of the durability and reliability of the liquid crystal panel 100 may be maximized. Further, using the united configuration as described above, at least a portion of the gap maintaining member 131 may be arranged on the lower portion of the scribe line SL without special consideration of the formation accuracy (formation width accuracy and formation position accuracy) of the gap maintaining member 131 and the formation accuracy (position accuracy) of the scribe line SL on the CF substrate 120, and thus the above-described effect may be relatively easily achieved. Further, the gap maintaining member 131 is made of the same material as the main seal pattern and the material that forms the main seal pattern and the gap maintaining member is made of a sealant in which the spacer 152 for maintaining the distance between the substrates in the predetermined range is mixed. Accordingly, in the sealant applying process, the gap maintaining member can be formed simultaneously with the main seal pattern or sequentially formed. Further, without the additional manufacturing process, the gap maintaining member 131 can be arranged to maintain the distance between the substrates in the predetermined range through the spacer 152 mixed in the sealant. Further, according to the first illustrative embodiment of this disclosure, in the portion of the gap maintaining member 131 to which the cut piece of the unnecessary portion of the mother CF substrate 20 opposed to the signal terminal 118, the gap maintaining member 131 is fixed to the mother TFT substrate 10 through the seal peeling auxiliary layer 154 that serves to help the peeling of the sealant forming the gap maintaining member 131 to the mother TFT substrate 10.
Accordingly, the TFT substrate 10 can be manufactured in a state where the occurrence of damage of the TFT substrate 10 is suppressed even when the gap maintaining member 131 is arranged over the unnecessary cut piece 155.

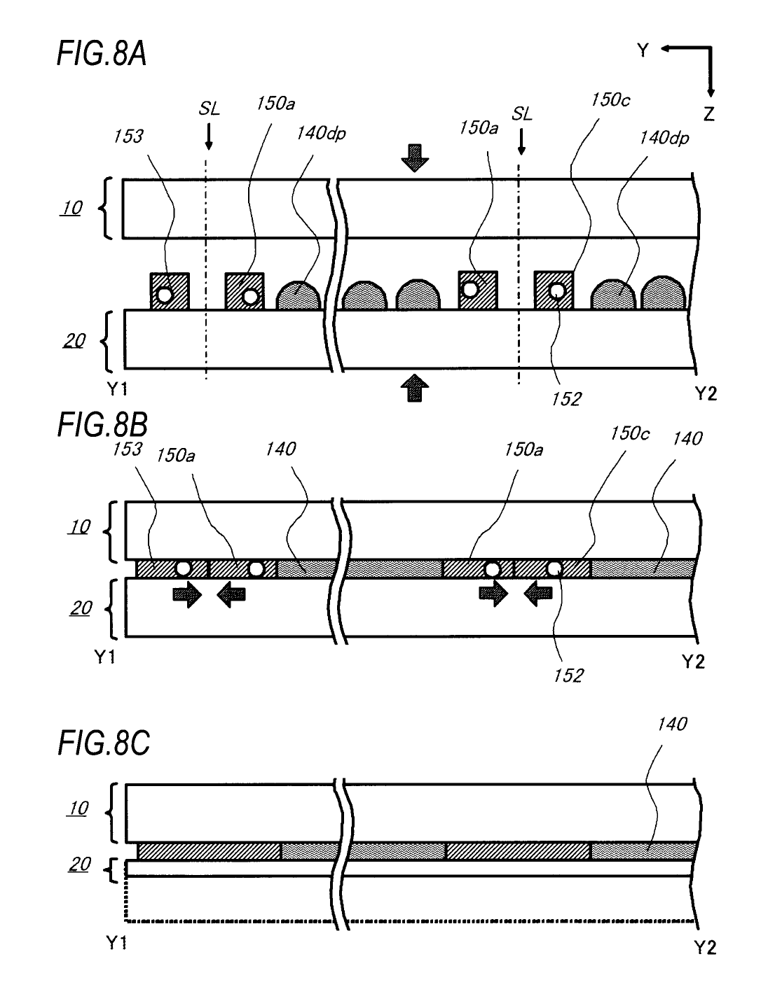

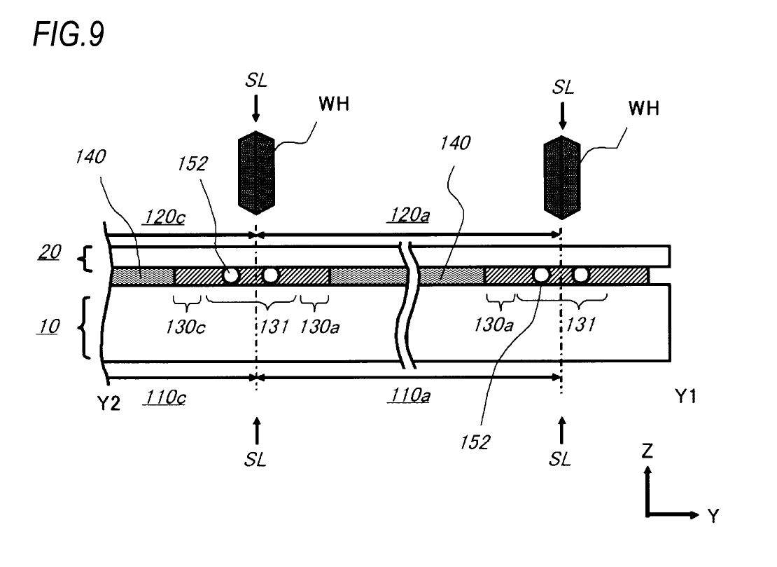

Additionally, in the first illustrative embodiment as described above, the main seal patterns 130a to 130f and the gap maintaining member 131 are formed and united in a manner that the main sealants 150a to 150f having a plurality of seal regions that surround and seal the liquid crystal member and the dummy sealants 151 arranged along the respective sides on the outside of the main sealants 150a to 150f are formed respectively, and after that the sealants are sandwiched and pressed by the mother TFT substrate 10 and the mother CF substrate 20 through bonding of the mother TFT substrate 10 and the mother CF substrate 20. Since the main sealants 150a to 150f and the dummy sealants 151 are made of the same material and are formed and united, the main seal patterns 130a to 130f and the gap maintaining member 131 are formed and united without being clearly distinguished. Accordingly, as in the first illustrative embodiment, it is not necessary to separately form the main sealants 150a to 150f and the dummy sealants 151. That is, it is also possible to omit the applying and forming of the dummy sealants 151. Hereinafter, a modified example of the first illustrative embodiment in which the applying and forming of the dummy sealants 151 is omitted will be described properly with reference to FIGS. 8 and 9.

First, FIG. 8A shows the sealant applying process S5 according to the modified example, and corresponds to the state in FIG. 5A according to the first illustrative embodiment before the mother TFT substrate 10 and the CF substrate 20 are bonded after the completion of the liquid crystal dropping process S6. Here, changed portions from the first illustrative embodiment will be mainly described, and the description of duplicate portions will be properly omitted. As illustrated in FIG. 8A, in the modified example, between the CF substrate 120a and the CF substrate 120c which are adjacently arranged, only the main sealant 150a and the main sealant 150c are arranged adjacent to the position in which the scribe line SL is formed (for convenience in explanation, the position in which the scribe line SL is formed later is shown in the drawing) when the CF substrate 120a and the CF substrate 120C are separated and cut, and the dummy sealants 151 formed according to the first illustrative embodiment are omitted. In comparison to the case of the first illustrative embodiment, the main sealant 150a and the main sealant 150c are arranged adjacent to the scribe line SL, a large amount of sealant is spread therein. To increase the applied amount, specifically in the case of applying through a screen printing device, the amount of sealant spread can be increased by thickening the pattern width of the opening pattern of the screen printing and forming the seal pattern having wide line width. In the case of applying and forming in the dispenser method, the amount of applying can be increased by setting a large discharge pressure. Further, at the end portion on the opposite side to the side to which the CF substrate 120c is adjacent, on the outside of the main sealant 150a, the dummy sealant 153 that is made of the same sealant as the main sealant 150a is arranged in a position that is almost symmetrical about the scribe line SL. The positional relationship between the dummy sealant 153 and the main sealant 150a about the scribe line SL and the amount of sealant spread may be configured to be equivalent to the positional relationship between the main sealant 150a, the main sealant 150c, and the scribe line SL and the amounts of the main sealant 150a and the main sealant 150c spread.

The mother TFT substrate 10 and the mother CF substrate 20 arranged opposite to each other as described above, similarly to the first illustrative embodiment, become adjacent in the direction of arrows in FIG. 8A, and are bonded as shown in FIG. 8B. As a result, the main sealants 150a and 150c, which are formed to have the seal regions that surround and seal the liquid crystal material, are sandwiched by the mother TFT substrate 10 and the mother CF substrate 20, and are spread by being pressed, and in the adjacent portion of the main sealant 150a and the main sealant 150c, the main sealant 150a, the main sealant 150c are united. Further, in the end portion on the opposite side to the adjacent side, the main sealant 150a and the dummy sealant 151 are united. The main sealant 150a, the main sealant 150c, and the dummy sealant 153 are configured by a same sealant, and the spacers 152 are mixed in the sealant similarly to the first illustrative embodiment. When the main sealant 150a, the main sealant 150c, and the dummy sealant 153 are pressed, the substrate spacing between the mother TFT substrate 10 and the mother CF substrate 20 is maintained by the spacers 152. Thereafter, similarly to the first illustrative embodiment, the sealant curing process S8, the thinning and polishing process S9 as shown in FIG. 8C, and the parallax barrier forming process S10 are sequentially performed to form the mother cell substrate 30. Since these processes are not especially different from those in the first illustrative embodiment, the detailed description thereof will be omitted.

Then, the scribe process S11 that is one of points in the modified example will be described. FIG. 9 shows the situation in the frame region of the CF substrate 120a and the TFT substrate 110 when the scribe process S11 is performed in the modified example, and corresponds to FIG. 6B when the scribe process S11 according to the first illustrative embodiment is described. With respect to the mother cell substrate 30 that is formed before the parallax barrier forming process S10, as shown in FIG. 9, the scribe line SL is formed on the surfaces of the mother TFT substrate 10 and the mother CF substrate 20. In comparison to the first illustrative embodiment, the method of forming the sealant arranged on the lower portion adjacent to the scribe line SL may differ from the sealant applying process S5. However, it has the same configuration, at which the sealant having a function of maintaining the distance between the mother CF substrate 20 and the mother TFT substrate 10 in the predetermined range and the sealant having a function of the main seal pattern that seals the liquid crystal layer 140 in the gap between the CF substrate 120 and the TFT substrate 110, which are arranged to surround the display region 200, are formed and united. Specifically as shown in FIG. 9, the sealant of the sealants arranged on the lower portion in the vicinity of the scribe line SL, which is arranged around the liquid crystal layer 140, becomes the main seal pattern 130a and the main seal pattern 130c, and the sealant, which is arranged just below the scribe line SL and has a function of maintaining the distance between the substrates in the predetermined range through being mixed with the spacers 152 that maintains the distance between the substrates in the predetermined range, becomes the gap maintaining member 131. Accordingly, as a result, similarly to the first illustrative embodiment, in the vicinity of the substrate end that corresponds to the cutting position of the CF substrate 120 made of ultra-thin glass, the gap maintaining member 131 for maintaining the distance between the TFT substrate 110 oppositely arranged in the predetermined range is provided. Since this gap maintaining member 131 is arranged to at least until the substrate end of the CF substrate 120 that corresponds to the lower portion of the cutting position, the effects of the first illustrative embodiment can be obtained. As described above, in the modified example, a process of applying and forming the dummy sealant 151 between the CF substrate adjacently arranged may be omitted. Accordingly, in the case of performing the sealant applying process through the screen-printing device, the opening pattern design of the screen-printing is changed and the increase and decrease effects of the process may not be obtained. However, in the case of using the dispenser method, the distance of a nozzle operates is shortened, and then the processing time is reduce and the production cost is decreased.

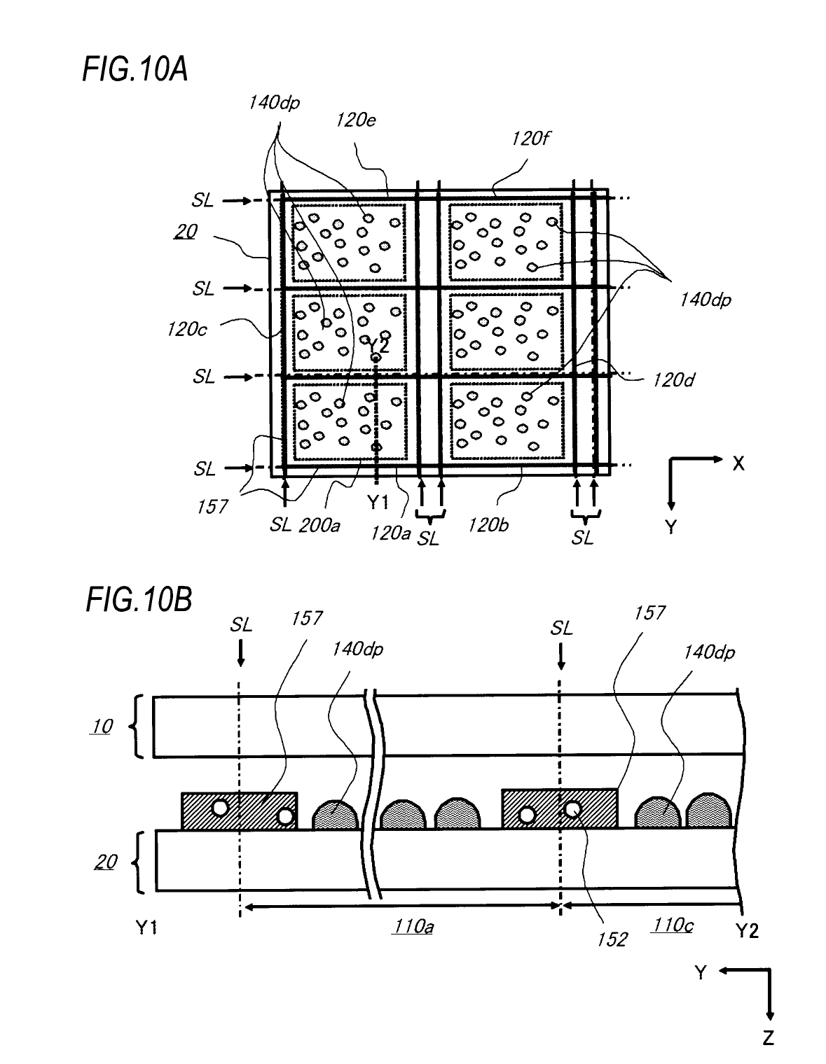

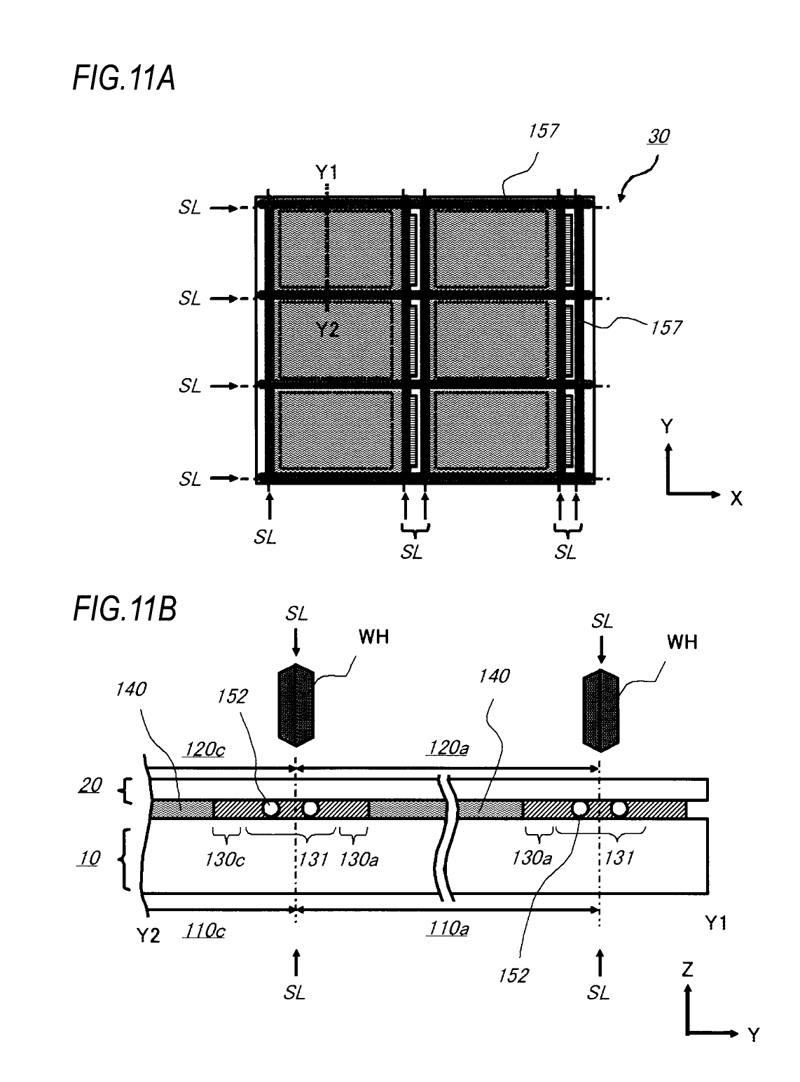

As shown in the description of the modified example, it is are formed and united that the sealant has the function of maintaining the distance between the mother CF substrate 20 and the mother TFT substrate 10 in the predetermined range and the sealant has the function as the main seal pattern that seals the liquid crystal layer 140 in the gap between the CF substrate 120 and the TFT substrate 10, which are arranged to surround the display region 200,. Accordingly, the same effect as the first illustrative embodiment is achieved. Accordingly, the modified example is not limited to the method of integrally forming the pattern of two main sealants, that is, the main sealant 150a and the main sealant 150c which are formed on both sides of the scribe line SL. One line of sealant that corresponds to the amount of sealant spread, when the patterns of the main sealant 150a and the main sealant 150c are united, from the first may be spread and formed on the scribe line SL, and the sealant may be extended and formed in the vicinity of the scribe line SL. Hereinafter, a method of forming a line of sealant in the vicinity of the scribe line SL according to a second modified example of the first illustrative embodiment will be described properly with reference to FIGS. 10 and 11.

First, FIG. 10A shows the state of the mother CF substrate 20 after the sealant applying process S5 and the liquid crystal dropping process S6 according to the second modified example, and corresponds to the state in FIG. 4A according to the first illustrative embodiment. Further, FIG. 10B corresponds to the state in which the mother TFT substrate 10 and the mother CF substrate 20 are oppositely arranged before they are bonded, that is, the state in FIG. 5A according to the first illustrative embodiment. Here, changed portions from the first illustrative embodiment will be mainly described, and the description of the duplicate portions will be properly omitted. As illustrated in the cross-sectional view illustrating FIG. 10A, in the second modified example, between the CF substrate 120a and the CF substrate 120c which are adjacently arranged, a main sealant 157 is formed, which is made of one line of sealant that is formed along the upper portion of the position in which the scribed line SL is formed (for convenience in explanation, the position in which the scribe line SL is formed later is shown in the drawing) when the CF substrate 120a and the CF substrate 120c are separated and cut. Further, as shown in the plan view illustrating FIG. 10A, even in the position in which the scribe line SL is formed, that is, in the position that corresponds to end portions of external shapes of all the CF substrate 120a to 120f, the main sealant 157 which is made of one line of sealant along the upper portion of the scribe line SL is formed similarly to that between the CF substrate 120a and the CF substrate 120c. Further, in order to efficiently form the main sealant 157 as described above, according to the second modified example, all the CF substrates 120a to 120f are closely arranged on the mother CF substrate 20 without the gap, and the main sealant 157, as shown in FIG. 10A, is formed to have a plurality of seal regions which are formed in a shape to surround the display regions 200a to 200f of the liquid crystal panels and surround and seal the liquid crystal member later, and the liquid crystal layer 140 is formed using the ODF method that drops a droplet-shaped liquid crystal member 140dp onto the respective seal regions.

As described above, according to the second modified example, between the respective CF substrates 120a to 120f or between the plurality of seal regions that surround and seal the liquid crystal member later, the main sealant 157 that is made of one united line of sealant is formed. Accordingly, similarly to the first illustrative embodiment and the modified example, it is not necessary to respectively form the main sealants 150a to 150f so as to surround the display regions 200a to 200f on the respective CF substrate 120a to 120f, but as shown in the plan view illustrating FIG. 10A, parallel main sealants 157 may be formed on the mother CF substrate 20 in parallel to the vertical direction and the horizontal direction, that is, in X and Y directions, according to the number of scribe lines SL. Similarly to the first illustrative embodiment, since it is exemplified that the signal terminal 118 is formed only on one side of the liquid crystal panel 100, two lines of main sealant 157 are formed between the adjacent panels in the direction (Y direction in the drawing) that is parallel to the formation region of the signal terminal 118, in which the formation region of the signal terminal 118 is arranged between the adjacent panels, and one line of main sealant 157 is formed between the adjacent panels in the direction (X direction in the drawing) that is perpendicular to the formation region of the signal terminal 118, in which the formation region of the signal terminal 118 is not arranged between the adjacent panels. On the other hand, as described above, since the main seal pattern 130 and the gap maintaining member 131 are formed on both sides of the scribe line SL according to the first illustrative embodiment by means of one line of main sealant 157, it is preferable to form the main sealant 157 with a thicker width in comparison to the main sealant 150 spread according to the first illustrative embodiment, and more specifically, with a width that is twice to three times thicker than the width of the main sealant 150 of the first illustrative embodiment. Further, according to the second modified example, in the case of applying and forming the sealant in the dispenser method, the distance in which the nozzle operates becomes significantly shorter in comparison to the first illustrative embodiment (at least between the adjacent CF substrates 120a to 120f, the formation of two or three lines of sealant can be reduced to the formation of one line of sealant, and thus the operation of nozzle is simply reduced to ½ to ⅓), and thus the processing time is reduced to contribute to the reduction of the production cost during the production.

The mother TFT substrate 10 and the mother CF substrate 20 which are oppositely arranged as shown in FIG. 10B are adjacent and bonded in the bonding process S7 similarly to the modified example of the first illustrative embodiment. As a result, the main sealant 157 that is formed along the upper portion of the position in which the scribe line SL is formed is sandwiched by the mother TFT substrate 10 and the mother CF substrate 20, and are spread by being pressed, and are spread crossing over both sides of the position in which the scribe line SL is formed. Further, in the main sealant 157 according to the second modified example, spacers 152 are mixed in the main sealant 150 similarly to the first illustrative embodiment. When the main sealant 157 is pressed, the substrate spacing between the mother TFT substrate 10 and the mother CF substrate 20 are maintained by the spacers 152. Thereafter, similarly to the first illustrative embodiment, the sealant curing process S8, the thinning and polishing process S9, and the parallax barrier forming process S10 are sequentially performed to form the mother cell substrate 30. Since these processes are not especially different from those in the first illustrative embodiment, the detailed description thereof will be omitted.

Then, the scribe process S11 in the second modified example will be described with reference to FIG. 11. FIG. 11A is a plan view illustrating the mother cell substrate 30 according to the second modified example, and FIG. 11B is a cross-sectional view taken along cross sectional line Y1-Y2 in FIG. 11A. FIGS. 11A and 11B correspond to FIGS. 6A and 6B according to the first illustrative embodiment, respectively. As illustrated in FIG. 11A, the main sealant 157 formed along the upper portion of the position in which the scribed line SL is spread crossing over both sides of the position in which the scribe line SL is formed, and the scribe line SL is formed on the surfaces of the mother TFT substrate 10 and the mother CF substrate. In comparison to the first illustrative embodiment or the modified example of the first illustrative embodiment as described above, the method of forming the sealant that is arranged on the lower portion adjacent to the scribe line SL may differ from the sealant applying process S5. However, it has the same configuration, at which the sealant having a function of maintaining the distance between the mother CF substrate 20 and the mother TFT substrate 10 in the predetermined range and the sealant having a function of the main seal pattern that seals the liquid crystal layer 140 in the gap between the CF substrate 120 and the TFT substrate 110, which are arranged to surround the display region 200, are formed and united. Specifically as shown in FIG. 11B, the sealant of the sealants arranged on the lower portion in the vicinity of the scribe line SL, which is arranged around the liquid crystal layer 140, becomes the main seal pattern 130a and the main seal pattern 130c, and the sealant, which is arranged just below the scribe line SL and has a function of maintaining the distance between the substrates in the predetermined range through being mixed with the spacers 152 that maintains the distance between the substrates in the predetermined range, becomes the gap maintaining member 131. Accordingly, as a result, similarly to the first illustrative embodiment or the modified example of the first illustrative embodiment as described above, in the vicinity of the substrate end that corresponds to the cutting position of the CF substrate 120 made of ultra-thin glass, the gap maintaining member 131 for maintaining the distance between the TFT substrate 110 oppositely arranged in the predetermined range is provided. Since this gap maintaining member 131 is arranged to at least until the substrate end of the CF substrate 120 that corresponds to the lower portion of the cutting position, the effects of the first illustrative embodiment can be obtained. Further, in the modified example, a process of applying and forming the dummy sealant 151 between the CF substrate adjacently arranged may be omitted.

Further, according to the second modified example, the gap maintaining member 131 is arranged on all substrate ends in the vicinity of the signal terminal 118 in the mother TFT substrate 10. Further, according to the first illustrative embodiment, the seal peeling auxiliary layer 154 is arranged, which serves to help the peeling of the sealant that forms the gap maintaining member 131 from the surface of the mother TFT substrate 10 when the unnecessary cut piece 155, which is necessary to be peeled off from the mother CF substrate 20 or the mother TFT substrate 10, is removed. Accordingly, in the second modified example, it is preferable to provide the seal peeling auxiliary layer 154 on a contact portions of all the gap maintaining members 131 and the mother TFT substrate 10, which are put on the unnecessary cut piece 155, that is, on the contact portions of the gap maintaining member 131 and the mother TFT substrate 10, which are over the entire circumference of the unnecessary cut piece 155.

According to the first and second modified examples of the first illustrative embodiment as described above, the same effect of the first illustrative embodiment is achieved. If the ODF method is to be applied, it is not necessary to form the liquid crystal inlet for injecting the liquid crystals through adopting a method of closely arranging all the CF substrates 120a to 120f on the mother CF substrate 20 without the gap and forming the liquid crystal layer 140. Accordingly, the main sealant 157 of a simple linear shape can be provided between the CF substrates 120a to 120f. As a result, since the main sealant 157 can be formed efficiently, the processing time is reduced and thus the production cost during the production is reduced.

### The Second Illustrative Embodiment

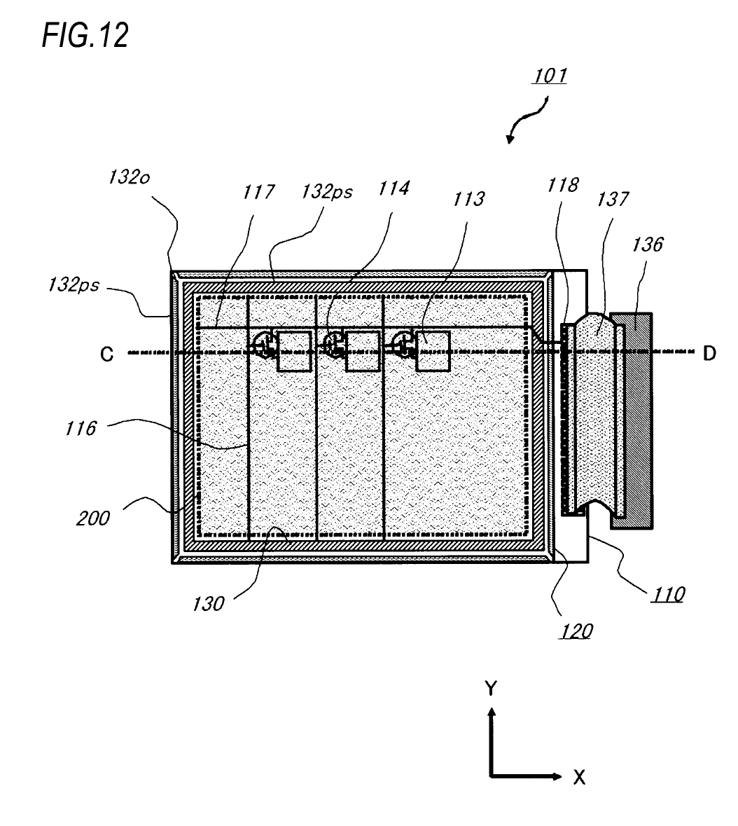

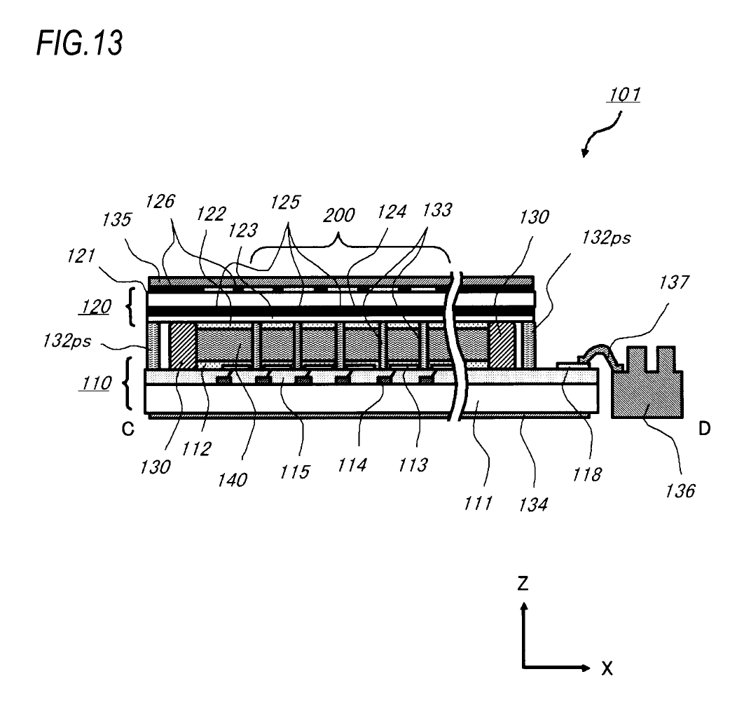

In the first illustrative embodiment, it is exemplified that the gap maintaining member 131 that is one of the characteristic configurations of this disclosure is formed by a common member with the main seal pattern. In the second illustrative embodiment, the gap maintaining member 131 is changed to a gap maintaining member 132ps formed by a common member with the cylindrical spacer 133. The configuration of the liquid crystal panel 101 that is used in the liquid crystal display device according to the second illustrative embodiment will be described with reference to schematic views of FIGS. 12 and 13. FIG. 12 is a plan view illustrating the whole configuration of a liquid crystal panel, and FIG. 13 is a cross-sectional view taken along cross-sectional line C-D in FIG. 12. The description of the configuration that is common to the configuration of the liquid crystal panel 100 according to the first illustrative embodiment will be properly omitted.

According to the liquid crystal panel according to the second illustrative embodiment, as shown in FIGS. 12 and 13, similarly to the first illustrative embodiment, a CF substrate 120 is made of a glass substrate 121 which is a transparent substrate made of ultra-thin glass of about 0.1 mm. On the outside of a main seal pattern 130 of a frame region in the lower portion of the CF substrate 120 made of the ultra-thin glass, a gap maintaining member 132ps for maintaining the gap between the substrates when the substrates are cut is provided. Similarly, to the first illustrative embodiment, this gap maintaining member 132ps is arranged on the lower portion of the scribe line SL that is formed to correspond to the substrate end of the CF substrate 120. Accordingly, the gap maintaining member 132ps is provided to extend to the substrate end of the CF substrate 120 even in the completed liquid crystal panel 101.

The difference between the gap maintaining member 132ps according to the second illustrative embodiment and the gap maintaining member 131 according to the first illustrative embodiment is that the gap maintaining member 132ps is configured by common member with a cylindrical spacer 133 arranged in a display region 200. Further, the gap maintaining member 132ps is arranged separately from the main seal pattern 130, and is formed with a predetermined width. The predetermined width is designed as a width in which at least a portion of the gap maintaining member 132ps is arranged on the lower portion of the scribe line SL, and the gap maintaining member 132ps is separated from the main seal pattern 130 in consideration of the formation accuracy (formation width accuracy and formation position accuracy) of the main seal pattern 130 and the gap maintaining member 132ps and the formation accuracy (position accuracy) of the scribe line SL on the CF substrate 120. On the other hand, to be described later, according to the second illustrative embodiment, since the gap maintaining member 132ps is formed simultaneously with the cylindrical spacer 133 and is formed in a photo-graving process, the non-uniformity of the formation accuracy itself of the gap maintaining member may be negligible in comparison to the formation accuracy of the scribe line SL. Accordingly, the predetermined width may be set to a width for which only the formation accuracy of the scribe line SL is considered. Specifically, as an example, it may be designed and managed that the gap maintaining member 132ps is formed with a width of about 0.7 mm, and the distance from the main seal pattern 130 is set to about 0.5 mm as an average value. The above-described values are exemplary, and may be properly determined according to the accuracy of the scribe forming device used and the sealant applying device forming the main seal pattern 130 and in consideration of the formation accuracy (formation width accuracy and formation position accuracy) of the main seal pattern 130 and the gap maintaining member 132ps and the formation accuracy (position accuracy) of the scribe line SL on the CF substrate 120. Further, as can be seen from the plan view illustrating FIG. 12, the gap maintaining member 132ps has openings 132o which are formed at four corners of the CF substrate 120 and have lengths substantially corresponding to the lengths of the four sides of the CF substrate 120.

Further, the cylindrical spacer 133 and the gap maintaining member 132ps are formed with the same height. Further, in order to match the gap between the substrates in each position in the display region 200 in which the cylindrical spacer 133 is formed and the frame region in which the gap maintaining member 132ps is formed, an insulating film 115 in the portion on which the cylindrical spacer 133 in the display regions 200 is arranged is formed on the portion on which the gap maintaining member 132ps is arranged in the same manner. Further, patterns or the like (not illustrated), which are formed on the same layer and with the same width as a BM 125, a common electrode 123 that overlaps the cylindrical spacer 133, a gate wiring 116 or a source wiring 117 that is arranged on the TFT substrate 110, may be properly arranged.

Further, a method of manufacturing a liquid crystal panel 101 according to the second illustrative embodiment of this disclosure will be described. In the method of manufacturing the liquid crystal panel 101 according to the second illustrative embodiment of this disclosure, processes that have the differences in comparison to the method of manufacturing the liquid crystal panel 100 of the first illustrative embodiment, such as a substrate preparing process Si for preparing the mother CF substrate 20 that forms the gap maintaining member 132ps arranged on the CF substrate, a sealant applying process S5 for performing applying of sealant on one surface of the mother CF substrate 20, a scribe process S11 for forming a scribe line SL on respective surfaces of the mother TFT substrate 10 and the mother CF substrate 20 with respect to the mother cell substrate 30, and a cell dividing process S12 for dividing the mother cell substrate 30 into individual cell substrates. It will be described focusing on the differences with the first illustrative embodiment.

First, in the substrate preparing process S1, a mother CF substrate 20 is prepared. Similarly to the mother CF substrate 20 according to the first illustrative embodiment, the mother CF substrate 20 in which six CF substrates 120a to 120f are formed may be prepared, and a cylindrical spacer 133 may be formed by applying and patterning a photosensitive resin film by a typical cylindrical spacer forming method. In the second illustrative embodiment of this disclosure, when patterning the photosensitive resin film that forms the cylindrical spacer 133 on the mother CF substrate 20, a gap maintaining member 132ps is simultaneously patterned and formed by the same photosensitive resin film. Accordingly, the cylindrical spacer 133 and the gap maintaining member 132ps are made of the same photosensitive resin film material at the same height, and are simultaneously formed (by a common patterning process). Further, the gap maintaining member 132ps is formed in a pattern shape of the gap maintaining member 132ps as described in the configuration of FIG. 12 in the position, in which the scribe line SL is formed in the scribe process S11, which is performed later. However, on the mother CF substrate 20, the gap maintaining member 132ps is formed for each of the CF substrates 120a to 120f that are arrange adjacent to both sides of the scribe line SL crossing over the both sides of the scribe line SL. Even in a planar arrangement, the gap maintaining member 132ps is arranged crossing over the both sides of the scribe line SL along the scribe line SL formed at the substrate end in each of the CF substrates 120a to 120f. On the other hand, it is not necessary that the gap maintaining member 132ps that is arranged crossing over the both sides of the scribe line SL is configured by a completely united pattern that is formed by the common member with the cylindrical spacer 133, but may be configured by closely arranging the pattern that is made of the cylindrical spacer 133 having the same shape as the cylindrical spacer 133 arranged on the display region 200. On the other hand, even when the cylindrical spacer is configured by a somewhat united pattern, it is preferable that the gap maintaining member is configured by the patterns that are separated by using the scribe line SL as the boundary.

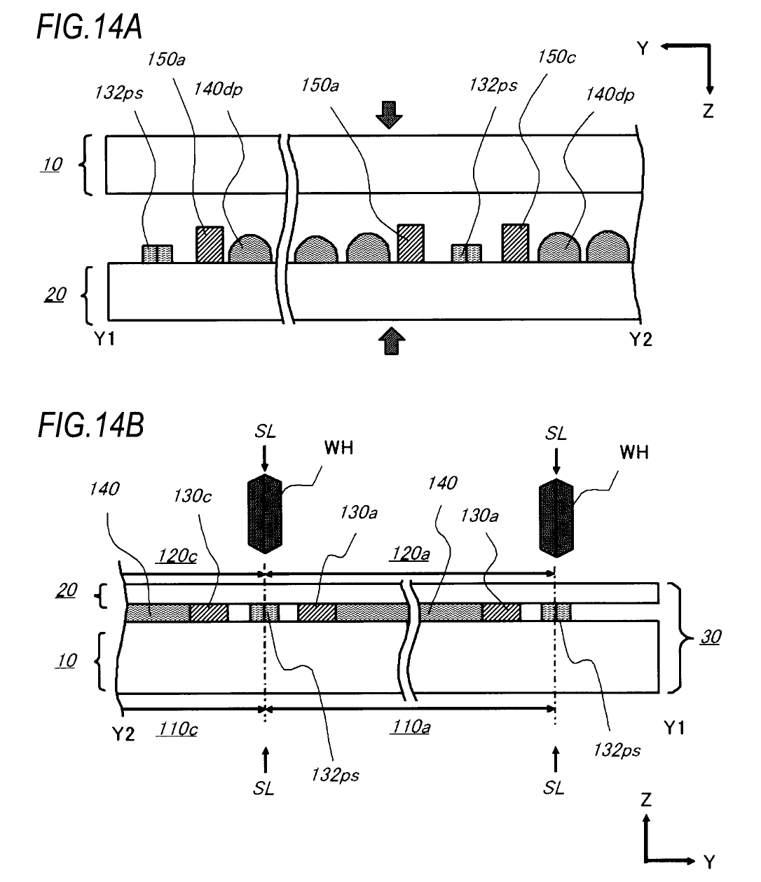

Then, FIG. 14A shows the sealant applying process S5 according to the second illustrative embodiment. FIG. 14A corresponds to the state the state in FIG. 5A according to the first illustrative embodiment, after the completion of the liquid crystal dropping process S6 and before the mother TFT substrate 10 and the mother CF substrate 20 are bonded. Here, changed portions from the first illustrative embodiment will be mainly described, and the description of duplicate portions will be properly omitted. As shown in FIG. 14A, in the second illustrative embodiment of this disclosure, between the CF substrate 120a and the CF substrate 120c which are adjacently arranged (corresponding to the upper portion of the cut line when the CF substrate 120a and the CF substrate 120c are separated and cut), the gap maintaining member 132ps is formed between the main sealant 150a and the main sealant 150c. In the end portion on the opposite side to a side on which the CF substrate 120c is adjacent to the CF substrate 120a, only the gap maintaining member 132ps is arranged on the outside of the main sealant 150a (corresponding to the cut line when the glass of the peripheral unnecessary portion surrounding the CF substrate 120a and the mother CF substrate 20 is separated and cut).

The mother TFT substrate 10 and the mother CF substrate 20 arranged opposite to each other as described above, in the bonding process S7 similarly to the first illustrative embodiment, become adjacent in the direction of arrows in FIG. 14A, and are bonded. As a result, the main sealants 150a and 150c are sandwiched by the mother TFT substrate 10 and the mother CF substrate 20, and are spread by being pressed, and the main seal pattern 130a and the main seal pattern 130c are formed. Further, when the mother TFT substrate 10 and the mother CF substrate 20 are bonded, the substrate spacing between the mother TFT substrate 10 and the mother CF substrate 20 is maintained by the gap maintaining member 132ps in the vicinity of the position in which the scribe line SL is formed between the CF substrate 120a and the CF substrate 120c that are adjacently arranged. Further, the gap maintaining member 132ps has openings 132o, which are formed at four corners of the CF substrate and has a divided configuration. Accordingly, the gap maintaining member is opened to the outside, and thus a completely closed space is not formed between the main seal patterns 130a to 30f and the gap maintaining member 132ps. Accordingly, when the state of the gap maintaining member is changed from a vacuum state to the open state to the atmosphere after bonding in the bonding process S7, seal punk (damage of sealant pattern) due to the difference in pressure between the closed space and the outside may not occur. After the bonding process S7, similarly to the first illustrative embodiment, the sealant curing process S8, the thinning and polishing process S9, and the parallax barrier forming process S10 are sequentially performed to form the mother cell substrate 30. However, these processes are not especially different from those according the second illustrative embodiment, and the detailed description thereof will be omitted.

Then, the scribe process S11 that is one of points in the second illustrative embodiment will be described. FIG. 14B shows the situation in the frame region of the CF substrate 120a and the TFT substrate 110 when the scribe process S11 is performed in the second illustrative embodiment. FIG. 14B corresponds to FIG. 6B in the scribe process S11 according to the first illustrative embodiment. With respect to the mother cell substrate 30 that is formed up to the parallax barrier forming process S10, as shown in FIG. 14B, the scribe line SL is formed on the surfaces of the mother

TFT substrate 10 and the mother CF substrate 20 by the wheel WH. However, according to the portion in which the scribe line SL is formed in the mother CF substrate 20 configured by ultra-thin glass that may be problematic, the gap maintaining member 132ps formed by the common member with the cylindrical spacer 133 arranged in the display region 200. By this gap maintaining means 132ps, the distance between the mother CF substrate 20 and the TFT substrate 10 can be maintained in the predetermined range. Accordingly, in order to form the cutting wound, even when the wheel WH is pressed onto the surface of the mother CF substrate 20 in the portion in which the scribe line SL is formed, the mother CF substrate 20 that is made of ultra-thin glass of about 0.1 mm is maintained by the gap maintaining member 131 without being deflected, and the repulsive force against the pressing of the wheel WH becomes stabilized. Accordingly, the rotation of the wheel H on the surface of the mother CF substrate 20 and the scanning of the wheel WH that is carried out by the rotation become stable. As a result, similarly to the first illustrative embodiment or modified example of the first illustrative embodiment, it is possible to form the stable scribe line SL, and thus the occurrence of inferiorities, such as remaining of cut damages including fine cracks on the end surface of the ultra-thin glass due to the cutting in the cell dividing process, which is to be described later, and cracking during cutting, can be suppressed.

Further, as described above, the gap maintaining member 132ps is arranged crossing over both sides of the scribe line SL along the scribe line SL that is formed at the substrate end of each of the CF substrates 120a to 120f. As the width of the gap maintaining member 132ps, at least a portion of the gap maintaining member 132ps is arranged on the lower portion of the scribe line SL and the gap maintaining member 132ps is separated from the main seal pattern 130 with the predetermined width with taking into consideration of the formation accuracy (formation width accuracy and formation position accuracy) of the main seal pattern 130 and the gap maintaining member 132ps and the formation accuracy (position accuracy) of the scribe line SL on the CF substrate 120. Accordingly, in forming the scribe line SL, at least a portion of the gap maintaining member 132ps is arranged on the lower portion of the mother CF substrate 20 made of ultra-thin glass in the portion, at which the wheel WH for forming the scribe line SL in the range of the seal position accuracy and the scribe position accuracy contacts. As a result, while forming the scribe line SL, the mother CF substrate 20 that is in contact with the scribe wheel WH is maintained on the lower portion by the gap maintaining member 132ps, and thus the stable scribe line SL can be formed.

Next, in the cell dividing process for dividing the mother cell substrate 30 into individual cell substrate 30 that is sequentially performed, similarly to the first illustrative embodiment, by applying stress in the vicinity of the scribe line SL that is formed in the above-described scribe process S11, the mother cell substrate 30 is divided into individual cell substrates, that is, the TFT substrates 110a to 110f and the CF substrates 120a to 120f. Even in the second illustrative embodiment of this disclosure, as described above, in the scribe line SL that is formed in the scribe process S11, the formation of the stable scribe line SL becomes possible, so that the incidence of fine cracks is reduced in the vicinity of the scribe line SL, and the linearity of the scribe line SL becomes good. Accordingly, the occurrence of inferiorities, such as remaining of cut damages including fine cracks on the end surface of the ultra-thin glass of the CF substrates 120a to 120f due to the cutting in the cell dividing process and the cracking during the cutting process, can be suppressed.

Further, during removing the cut piece of the unnecessary portion that is necessary to be removed from the mother CF substrate 20 or the mother TFT substrate 10 in the cell dividing process S12, in the first illustrative embodiment, by arranging the seal peeling auxiliary layer 154 that serves to help the peeling of the sealant that forms the gap maintaining member 131 from the mother TFT substrate 10, the removal of the unnecessary cut piece 155 is facilitated, and thus the damage of the TFT substrate 110 is suppressed from occurring. The gap maintaining member 132ps in the second illustrative embodiment is arranged separately from the main seal pattern 130 and is formed by the common member with the cylindrical spacer 133. Accordingly, the mother CF substrate 20 and the mother TFT substrate 10 are not completely bonded and united (the cylindrical spacer 133 and the gap maintaining member 132ps are fixed to only one side of the mother CF substrate 20 and the mother TFT substrate 10, and the cylindrical spacer 133 and the gap maintaining member 132ps are fixed to only the mother CF substrate 20 in the second illustrative embodiment or the first illustrative embodiment), and thus the unnecessary cut piece 155 is not fixed to the mother TFT substrate 10 to facilitate the removal of the unnecessary cut piece 155. That is, it is possible to omit the arrangement of the seal peeling auxiliary layer 154, and similarly to the first illustrative embodiment, even in the case of arranging the gap maintaining member 132ps crossing over the unnecessary cut piece 155, the damage of the TFT substrate 110 can be prevented from occurring. Further, if the gap maintaining member 132ps is configured by the separated pattern using the scribe line SL as a boundary, it is further easy to remove the unnecessary cut piece 155. Additionally, the above-described operation is not limited to the case where the gap maintaining member 132ps is formed by the common member with the cylindrical spacer 133. Even when dividing and arranging the gap maintaining member 132ps from the seal pattern 130, the fixing degree of the unnecessary cut piece 155 to the mother TFT substrate 10 becomes weak, and some effect for suppressing the damage of the TFT substrate 110 from occurring is obtained.

Since the procedure after the cell separation process S12 is the same as that according to embodiment form 1, the detail description thereof will be omitted, and here, the description of the method of manufacturing the liquid crystal panel 101 according to the second illustrative embodiment will be finished. In the liquid crystal panel 101 configuring the liquid crystal display according to the second illustrative embodiment in which the configuration and the manufacturing method are sequentially described, in comparison to the first illustrative embodiment or the modified example of the first illustrative embodiment, the different point is that the sealant that has a function of maintaining the distance between the mother CF substrate 20 and the mother TFT substrate 10 arranged on the lower portion in the vicinity of the scribe line SL in the predetermined range is changed to the gap maintaining member 132ps formed by the common member with the cylindrical spacer 133 arranged in the display region 200. However, in the vicinity of the substrate end that corresponds to the cutting position of the CF substrate 120 made of ultra-thin glass, the gap maintaining member 132ps for maintaining the distance between the TFT substrate 110 that is oppositely arranged in the predetermined range is provided, and the gap maintaining member 132ps is arranged to at least the substrate end of the CF substrate 120 that corresponds to the lower portion of the cutting position. Accordingly, the second illustrative embodiment has the same configuration as that according to the first illustrative embodiment or the modified example of the first illustrative embodiment. Accordingly, similarly to the first illustrative embodiment or the modified example of the first illustrative embodiment, in order to form the cutting wound on the surface of the mother CF substrate 20 from which the CF substrates 120 are cut out, even when the wheel WH is pressed onto the surface of the mother CF substrate 20 made of ultra-thin glass, the mother CF substrate 20 is maintained by the gap maintaining member 131 without being deflected, and the repulsive force against the pressing of the wheel WH becomes stabilized. Further, the rotation of the wheel WH on the surface of the mother CF substrate 20 and the scanning of the wheel WH carried out by the rotation become stable, and thus the forming of a stable scribe line SL becomes possible. Further, since the forming of the stable scribe line SL is possible, the occurrence of fine cracks in the vicinity of the scribe line SL is decreased, and the linearity of the scribe line SL becomes good. Further, by performing the cell dividing process on the basis of the scribe line SL formed as described above, the occurrence of inferiorities, such as remaining of cut damages including fine cracks on the end surface of the ultra-thin glass due to cutting and cracking during cutting, can be suppressed. Further, since the gap maintaining member 132ps is arranged up to the substrate end of the CF substrate 120 made of the ultra-thin glass substrate, the vicinity of the cross-section of the ultra-thin glass of the liquid crystal panel 100 can be reinforced, and as a result, the durability and reliability of the liquid crystal display can be improved.

In the liquid crystal panel according to the second illustrative embodiment, the gap maintaining member 132ps is made of the same material as the cylindrical spacer 133. Accordingly, the gap maintaining member 132ps can be formed simultaneously with the cylindrical spacer 133 when the cylindrical spacer 133 is formed. Accordingly, without the additional manufacturing process, it is possible to arrange the gap maintaining member 132ps that can maintain the distance between the substrates made of a common material as the cylindrical spacer 133 in the predetermined range. Further, since the gap maintaining member 132ps is arranged separately from the main seal pattern 130 in the vicinity of the scribe line SL and is formed by the common member with the cylindrical spacer 133, in the cell dividing process, it is easy to remove the unnecessary cut piece 155 made of the portion of the mother CF substrate 20 that is opposed to the signal terminal 118, and the occurrence of damage such as cracking of the TFT substrate 110 is suppressed, so that high yield of production is achieved. Further, by forming the gap maintaining member 132ps with a predetermined width in consideration of the formation accuracy of the main seal pattern 130 and the formation accuracy of the cutting wound on one side of the substrate that is made ultra-thin glass, in forming the scribe line SL, at least a portion of the gap maintaining member 132ps is arranged on the lower portion of the mother CF substrate 20 made of ultra-thin glass, which the wheel WH for forming the scribe line SL contacts, and the effect through forming the scribe line stably as described above can be certainly obtained. Further, since the gap maintaining member 132ps is designed with a predetermined width in which the gap maintaining member 132ps is separated from the main seal pattern 130, it is easy to remove the unnecessary cut piece 155. Further, the gap maintaining member 132ps has openings 132o, which are formed at four corners of the CF substrate and has a divided configuration. Accordingly, in the bonding process S7, seal punk (damage of sealant pattern) due to the difference in pressure between the closed space and the outside does not occur, so that high yield of production is achieved.

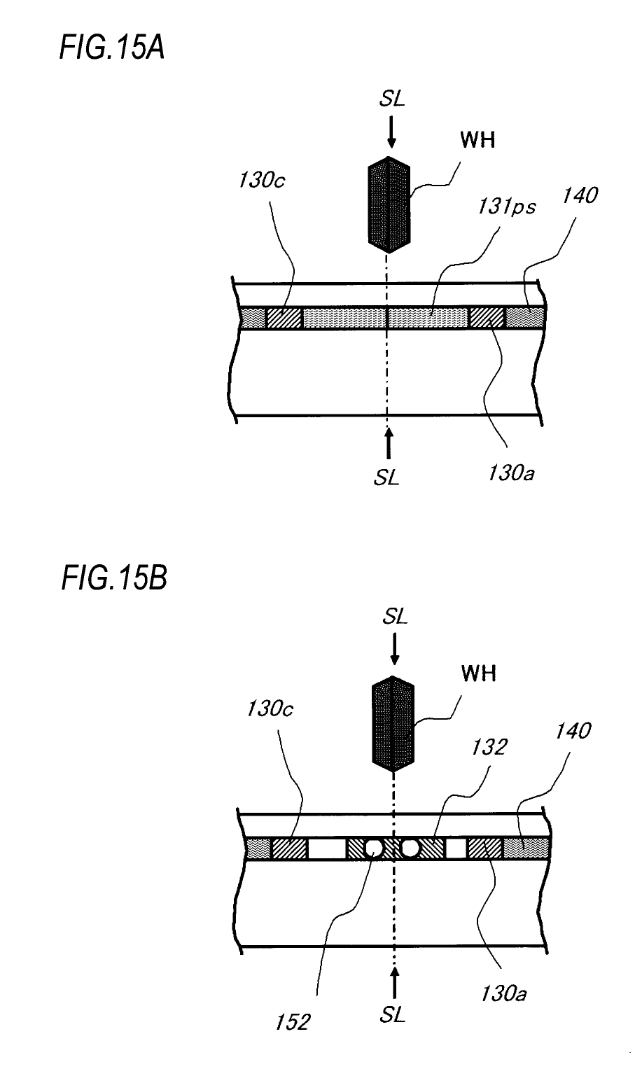

In the liquid crystal panel 101 configuring the liquid crystal display according to the second illustrative embodiment as described above, the gap maintaining member 132ps formed by the common member with the cylindrical spacer 133 arranged in the display region 200 is arranged separately from the main seal pattern 130. The gap maintaining member 132ps formed by the common member with the cylindrical spacer 133, as illustrated in FIGS. 15A and 15B, may be partially modified the configuration. On the other hand, FIGS. 15A and 15B are cross-sectional views illustrating the configuration of the scribe line SL and the gap maintaining member between the CF substrate 120a and the CF substrate 120c, which are adjacent to each other in the scribe process S11. FIGS. 15A and 15B correspond to the portion between the CF substrate 120a and the CF substrate 120c of FIG. 14B according to the second illustrative embodiment. For example, in one modified example, as shown in FIG. 15A, similarly to the gap maintaining member 131 according to the first illustrative embodiment, it may be changed that the gap maintaining member 132ps is formed to fill from the scribe line SL that is the substrate end up to the region in which the main seal pattern 130 that is arranged on both sides or one side of the scribe line SL is formed. On the other hand, similarly to the second illustrative embodiment, it is not necessary that the formation portion of the gap maintaining member 132ps is configured by a completely united pattern formed by the common member with the cylindrical spacer 133. For example, it may be configured the high-density pattern made of the common member with the cylindrical spacer 133 having the same shape as the cylindrical spacer 133 arranged in the display region 200. In the case of the configuration in which the gap maintaining member 132ps is formed to fill the region in which the main seal pattern 130 is formed, at least a portion of the gap maintaining member 132ps is arranged on the lower portion of the scribe line SL without specially consideration of the formation accuracy of the scribe line SL, and thus the effect of stably forming the scribe line SL can be relatively easily achieved. Further, since the gap maintaining member 132ps is formed by the common member with the cylindrical spacer 133, similarly to the second illustrative embodiment, in the cell separation process, it is easy to remove the unnecessary cut piece 155 made of the portion of the mother CF substrate 20 that is opposed to the signal terminal 118, and the occurrence of the damage such as cracking of the TFT substrate 110 is suppressed, so that high yield of production is achieved.

Further, in the other modified example, as shown in FIG. 15A, similarly to the gap maintaining member 132ps according to the second illustrative embodiment, it may be changed that the gap maintaining member 132 has a configuration arranged separately from the main seal pattern 130 by the sealant mixed with the spacer 152 for maintaining the distance between the substrate made of the main seal pattern 130 and the common member similarly to the gap maintaining member 131 according to the first illustrative embodiment. In this case, the gap maintaining member 132 may be made of the same material as the main seal pattern 130 and may be formed simultaneously with the main seal pattern 130 when the main seal pattern 130 is formed. Accordingly, without the additional manufacturing processes, the gap maintaining member 132 for maintaining the distance between the substrates in the predetermined range can be arranged. Further, similarly to the configuration according to the second illustrative embodiment in the vicinity of the scribe line SL, by arranging the gap maintaining member 132 separately from the main seal pattern 130, in the cell dividing process, it is easy to remove the unnecessary cut piece 155 that is made of the portion of the mother CF substrate 20 that is opposed to the signal terminal 118, and the occurrence of the damage, such as cracking of the TFT substrate 20 or the like, can be suppressed, so that high yield of production is achieved. Additionally, in comparison to the first illustrative embodiment, since the configuration of the gap maintaining member 132 is arranged separately from the main seal pattern 130 and a region that is fixed to both the mother TFT substrate 10 similarly to the second illustrative embodiment and the mother CF substrate 20 is small, damage is difficult to occur when the unnecessary cut piece 155 is removed, even when the seal peeling auxiliary material provided in the first illustrative embodiment is not arranged. However, in comparison to the configuration of the second illustrative embodiment, since the gap maintaining member 132 is a configuration that is fixed to both the mother TFT substrate 10 and the mother CF substrate 20, similarly to the first illustrative embodiment, it is preferable that the seal peeling auxiliary material is properly arranged, so that more high yield of production is achieved. Further, since a gap is formed between the gap maintaining member 132ps and the main seal pattern 130, similarly to the gap maintaining member 132ps according to the second illustrative embodiment, it is preferable to take the divided configuration that has openings 132o at four corners of the CF substrate, and in the bonding process S7, seal punk (damage of sealant pattern) due to the difference in pressure between the closed space and the outside does not occur, so that high yield of production is achieved.

Further, similarly to the gap maintaining member 132ps of the second illustrative embodiment, it is preferable to form the gap maintaining member 132 with the predetermined width in consideration of the formation accuracy of the main seal pattern 130 and the formation accuracy of the cutting wound of one of substrates made of ultra-thin glass. However, since the width or the like of the sealant that forms the gap maintaining member 132 is changed after the bonding process rather than when the sealant is spread on the mother CF substrate 20, it is necessary to set the width after the bonding process so that it has the same width as the gap maintaining member 132ps. Specifically, if it is assumed that the predetermined width that is the same as that of the gap maintaining member 132ps is set to, for example, about 0.7 mm similarly to the second illustrative embodiment, the value that is obtained by multiplying 0.7 mm by the distance between the substrates and then dividing the resultant value by the height of the sealant may be the rough guide of the width of the formed sealant. Further, since the formation positional accuracy of the gap maintaining member 132 is lower than the formation positional accuracy of the gap maintaining member 132ps, it is preferable to design the distance between the gap maintaining member 132 and the main seal pattern 130 with a small margin of about 0.7 mm. On the other hand, similarly to the second illustrative embodiment, the above-described values are exemplary and may be properly adjusted to a predetermined value in consideration of the formation accuracy (formation width accuracy and formation position accuracy) of the main seal pattern 130 and the gap maintaining member 132 and the formation accuracy (position accuracy) of the scribe line SL on the CF substrate 120 according to the used scribe forming device and the accuracy of the applying device of the sealant that forms the gap maintaining member 132 and the main seal pattern 130. As described above, in the scribe process S11, since the gap maintaining member 132 is formed with the predetermined width, in forming the scribe line SL, at least a portion of the gap maintaining member 132 is arranged on the lower portion of the mother CF substrate 20 made of ultra-thin glass, which is the portion that the wheel WH for forming the scribe line SL contacts, and thus the stable scribe line SL that is the same as in the second illustrative embodiment can be certainly formed. Further, by designing the gap maintaining member 132 with the predetermined width in which the gap maintaining member 132 is separated from the main seal pattern 130, it is easy to remove the unnecessary cut piece 155.

According to the first illustrative embodiment, the second illustrative embodiment, and the modified example, application examples of this disclosure, the dual-screen display liquid crystal panel in which only one of substrates is made of ultra-thin glass is described. According to this disclosure, since a common effect is obtained when at least one of substrates is made of ultra-thin glass, it is possible to apply this disclosure to a curved display in which ultra-thin glass is used in both sides of the TFT substrate and the CF substrate or a reflection type display in which ultra-thin glass is used in one of substrates. Further, according to the first illustrative embodiment, the second illustrative embodiment, and modified example, it has been described that the representative thickness of the substrate that is considered to be made of ultra-thin glass is about 0.1 mm. According to the first illustrative embodiment, the second illustrative embodiment, and the modified example of this disclosure, a great effect can be achieved from a liquid crystal display using an ultra-thin glass substrate with a thickness of less than 0.2 mm, in comparison to a general liquid crystal display using an ultra-thin glass substrate having a thickness of about 0.3 mm. Further, with respect to the lower limit, it is considered that the substrate thickness of the lower limit of the glass substrate that is used in liquid crystal displays described in the related art document is equal to or larger than 0.01 mm. Accordingly, it is defined that the ultra-thin glass used in the specification is glass having the substrate thickness in the range of equal to or larger than 0.01 mm and less than 0.2 mm. As described above, the glass substrate is not limited to the ultra-thin glass of about 0.1 mm exemplified according to the first illustrative embodiment, the second illustrative embodiment, and the modified example. Even in the case of using the ultra-thin glass having the substrate thickness in the range of equal to or larger than 0.01 mm and less than 0.2 mm, the same effects as in the first illustrative embodiment, the second illustrative embodiment, and modified example can be achieved.

What is claimed is:

1. A liquid crystal display comprising:
a pair of substrates, which face with each other, wherein at least one of the pair of substrates is made of ultra-thin glass;
a liquid crystal member arranged between the pair of substrates;
a main seal pattern arranged between the pair of substrates to bond the pair of substrates and to surround and seal the liquid crystal material; and
a gap maintaining member, which is arranged to at least a substrate edge in the vicinity of a substrate edge formed by cutting the at least one of the substrates made of the ultra-thin glass, and which maintains a distance between the pair of substrates in a predetermine range.

2. The liquid crystal display according to claim 1,
wherein the gap maintaining member is formed to be separated from the main seal pattern.

3. The liquid crystal display according to claim 2,
wherein the gap maintaining member includes an opening,
wherein the opening is opened from a space formed between the gap maintaining member and the main seal pattern to outside of a region surrounded by the gap maintaining member.

4. The liquid crystal display according to claim 1,
wherein the gap maintaining member is formed to fill a region from the substrate edge to the main seal pattern.

5. The liquid crystal display according to claim 1,
wherein column spacers are arranged on a display region to maintain the distance between the pair of substrates in the predetermined range, and
wherein the gap maintaining member is made of the same material as the column spacers and has the same height.

6. The liquid crystal display according to claim 1,
wherein spacers are mixed into the main seal pattern to maintain the distance between the pair of substrates in the predetermined range, and
wherein the gap maintaining member is made of the same material as the main seal pattern.

7. A method of manufacturing a liquid crystal display described in claim 6, comprising:
preparing a pair of mother substrates;
forming a main seal pattern having a plurality of seal regions configured to surround and seal liquid crystal material, on one of the pair of mother substrates;
dropping liquid crystal member in the plurality of seal regions of the main sealant; and
forming a united configuration, in which the main seal patterns and the gap maintaining member arranged between the main seal pattern is united by bonding the pair of mother substrates.

8. A method of manufacturing a liquid crystal display, comprising:
preparing a pair of mother substrates;
forming a main seal pattern having a plurality of seal regions configured to surround and seal liquid crystal member and a gap maintaining member between the main seal pattern, on one of the pair of mother substrates;
forming a united configuration, in which the main seal patterns and the gap maintaining member is united by bonding the pair of mother substrates; and
cutting the bonded mother substrates at a position corresponding to the gap maintaining member.

9. A method of manufacturing a liquid crystal display, comprising:
preparing a pair of mother substrates;
forming a main seal pattern having a plurality of seal regions configured to surround and seal liquid crystal material, on either one of the pair of mother substrates;
arranging a gap maintaining member, which maintains a distance between the pair of substrates in a predetermine range, between the plurality of seal regions;
bonding of the pair of mother substrates;
thinning of at least one of the pair of mother substrates to configure ultra-thin glass; and
forming a scribe line to cut off the at least one of the pair of mother substrates, at a position corresponding to the gap maintaining member on the at least one of the pair of mother substrates.
